(19) United States
(12) Patent Application Publication
(10) Pub. No.: US 2025/0117016 A1
(43) Pub. Date: Apr. 10, 2025

(54) ELECTRONIC DEVICE AND CONTROL METHOD THEREFOR

(71) Applicant: SAMSUNG ELECTRONICS CO., LTD., Suwon-si (KR)

(72) Inventors: Injoo KIM, Suwon-si (KR); Kyongsu KIM, Suwon-si (KR); Hankyeol KIM, Suwon-si (KR); Dongmin SHIN, Suwon-si (KR); Sangwuk CHAE, Suwon-si (KR); Junu HONG, Suwon-si (KR)

(73) Assignee: SAMSUNG ELECTRONICS CO., LTD., Suwon-si (KR)

(21) Appl. No.: 18/983,974

(22) Filed: Dec. 17, 2024

Related U.S. Application Data
(63) Continuation of application No. PCT/KR2023/010152, filed on Jul. 17, 2023.

(30) Foreign Application Priority Data
Aug. 31, 2022 (KR) 10-2022-0109982

(51) Int. Cl. G05D 1/243; A47L 9/28; G01C 21/00; G01S 7/48; G01S 17/86; G01S 17/89; G05D 1/242; G05D 1/246; G05D 1/648

(52) U.S. Cl. CPC G05D 1/2437; G01C 21/3841; G01C 21/387; G01S 7/4808; G01S 17/86; G01S 17/89; G05D 1/2424; G05D 1/2427; G05D 1/2462; A47L 9/2805; A47L 9/2857; A47L 2201/04; G05D 1/648

(57) ABSTRACT

A electronic device comprising a sensor unit, a memory, and at least one processor that: obtains, by the sensor unit, first sensing data including an image captured at the location; obtains map information on the basis of the first sensing data; combines the first sensing data and the second sensing data to obtain first mapping information and stores same in the memory; obtains second mapping information by removing data corresponding to a pre-configured condition corresponding from the stored first mapping information; identifies spatial information including feature data corresponding to a space included in the map information on the basis of the second mapping information; and controls traveling of the electronic device on the basis of the map information and the spatial information.

### CROSS-REFERENCE TO RELATED APPLICATION

This application is a continuation application, under 35 U.S.C. § 111(a), of international application No. PCT/KR2023/010152, filed Jul. 17, 2023, which claims priority under 35 U.S.C. § 119 to Korean Patent Application No. 10-2022-0109982, filed on Aug. 31, 2022, the disclosures of which are incorporated herein by reference in their entireties.

### TECHNICAL FIELD

The present disclosure relates to an electronic device and a control method therefor, and more particularly, to an electronic device and a control method therefor that utilize images in a driving operation of an electronic device.

### BACKGROUND ART

A mobile electronic device may be driven according to a user's command or a preset algorithm. Here, the electronic device may acquire map data for driving. Specifically, the electronic device may generate map data to identify a moving path for a specific purpose. Here, the electronic device may generate map data by exploring the surrounding space.

Even after the map data is generated, the electronic device needs to accurately identify a current location. However, the accuracy is low when the location is re-recognized in an environment different from the existing environment or when the location is re-recognized in an environment with similar characteristics.

In addition, it takes long time to recognize the location when the location is re-recognized in an environment with a large space size.

### DISCLOSURE

### Technical Solution

The present disclosure provides a device that controls driving by considering both a location and an image and deletes data corresponding to some preset conditions among sensing data to improve a processing speed.

According to an embodiment of the present disclosure, an electronic device includes: a sensor unit; a memory; and at least one processor configured to acquire first sensing data including a location of the electronic device and second sensing data including an image captured at the location through the sensor unit, acquire map information based on the first sensing data, combine the first sensing data and the second sensing data to acquire first mapping information and store the acquired first mapping information in the memory, delete data corresponding to a preset condition from the stored first mapping information to acquire second mapping information, identify space information of a space in which the electronic device is to be driven which includes feature data corresponding to the space included in the map information based on the second mapping information, and control driving of the electronic device in the space based on the map information and the space information.

The at least one processor may be configured to identify the space based on the map information, acquire the feature data corresponding to the space based on an image captured in the space that is among the second mapping information, and store the space information including the feature data corresponding to the space in the memory.

The at least one processor may be configured to identify, based on a preset event being identified, the location of the electronic device based on the map information and the space information, and the preset event may include at least one of an event in which the electronic device is moved by more than a threshold distance, an event in which driving of the electronic device is terminated, or an event in which a user command is received during driving of the electronic device.

The sensor unit may include a lidar sensor and an image sensor, and the at least one processor may be configured to acquire the first sensing data through the lidar sensor and acquire the second sensing data through the image sensor.

The at least one processor may be configured to acquire, based on a user input received for driving the electronic device, the first sensing data and the second sensing data while the driving corresponding to the user input is performed, and delete, based on termination of the driving, data corresponding to the preset condition from the first mapping information to acquire the second mapping information.

The at least one processor may be configured to combine location and image sensed at a same time to acquire the first mapping information.

The first mapping information may include a plurality of mapping data, and the at least one processor may be configured to identify data corresponding to the preset condition among the plurality of mapping data based on at least one of a location, a sensing time, or a rotation angle.

The first mapping information may include first mapping data and second mapping data, and the at least one processor may be configured to identify one of the first mapping data or the second mapping data as data corresponding to the preset condition based on a difference between a location of the first mapping data and a location of the second mapping data being less than a threshold distance.

The at least one processor may be configured to identify mapping data corresponding to a preset location among the plurality of mapping data as data corresponding to the preset condition.

The first mapping information may include a plurality of mapping data, and the at least one processor may be configured to identify data corresponding to the preset condition among the plurality of mapping data, based on the number of feature data or at least one of preset feature data.

According to another embodiment of the present disclosure, a control method of an electronic device includes: acquiring first sensing data including a location of the electronic device and second sensing data including an image captured at the location; acquiring map information based on the first sensing data; combining the first sensing data and the second sensing data to acquire and store first mapping information; deleting data corresponding to a preset condition corresponding to a repeated image in the stored first mapping information to acquire second mapping information; identifying space information of a space in which the electronic device is to be driven which includes feature data corresponding to the space included in the map information based on the second mapping information; and controlling driving of the electronic device in the space based on the map information and the space information.

The identifying of the space information may include: identifying the space based on the map information and acquiring the feature data corresponding to the space based on an image captured in the space that is among the second mapping information, and the controlling of the driving of the electronic device may include storing the space information including the feature data corresponding to the space.

The controlling of the driving of the electronic device may include: identifying, based on a preset event being identified, the location of the electronic device based on the map information and the space information, and the preset event includes at least one of an event in which the electronic device is moved by more than a threshold distance, an event in which driving of the electronic device is terminated, or an event in which a user command is received during driving of the electronic device.

The acquiring of the first sensing data and the second sensing data may include: acquiring the first sensing data through a lidar sensor of the electronic device; and acquiring the second sensing data through an image sensor of the electronic device.

The acquiring of the first sensing data and the second sensing data may include: acquiring, based on a received user input for driving the electronic device, the first sensing data and the second sensing data while the driving corresponding to the user input is performed, and deleting, based on termination of the driving, data corresponding to the preset condition from the first mapping information to acquire the second mapping information.

The storing of the first mapping information may include combining location and image sensed at the same time to acquire the first mapping information.

The first mapping information may include a plurality of mapping data, and the at least one processor may be configured to identify data corresponding to the preset condition among the plurality of mapping data based on at least one of a location, a sensing time, or a rotation angle.

The first mapping information may include first mapping data and second mapping data, and the acquiring of the second mapping information may include identifying one of the first mapping data or the second mapping data as data corresponding to the preset condition based on a difference between a location of the first mapping data and a location of the second mapping data being less than a threshold distance.

The acquiring of the second mapping information may include identifying mapping data corresponding to a preset location among the plurality of mapping data as data corresponding to the preset condition.

The first mapping information may include a plurality of mapping data, and the acquiring of the second mapping information may include identifying data corresponding to the preset condition among the plurality of mapping data, based on the number of feature data or at least one of preset feature data.

### DESCRIPTION OF DRAWINGS

FIG. 1 is a block diagram illustrating an electronic device according to various embodiments.

FIG. 2 is a block diagram illustrating a specific configuration of the electronic device of FIG. 1 according to various embodiments.

FIG. 3 is a diagram illustrating a location recognition module included in an electronic device according to various embodiments.

FIG. 4 is a flowchart illustrating an operation of deleting duplicate data from sensing data according to various embodiments.

FIG. 5 is a flowchart for specifying the operation of FIG. 4. according to various embodiments

FIG. 6 is a flowchart illustrating an operation of deleting duplicate data from sensing data acquired through a plurality of sensing according to various embodiments.

FIG. 7 is a flowchart illustrating an operation of controlling driving based on sensing data according to various embodiments.

FIG. 8 is a diagram illustrating a driving path of an electronic device according to various embodiments.

FIG. 9 is a diagram illustrating mapping data according to various embodiments.

FIG. 10 is a flowchart illustrating an operation of acquiring mapping data according to various embodiments.

FIG. 11 is a flowchart illustrating an operation of dividing space based on map information according to various embodiments.

FIG. 12 is a flowchart illustrating an operation of acquiring mapping data using time data according to various embodiments.

FIG. 13 is a flowchart illustrating an operation of deleting duplicate data based on a critical distance according to various embodiments.

FIG. 14 is a diagram illustrating a rotation angle of an electronic device according to various embodiments.

FIG. 15 is a diagram illustrating an image acquired according to a rotation angle of an electronic device according to various embodiments.

FIG. 16 is a flowchart illustrating an operation of deleting duplicate data based on a critical angle according to various embodiments.

FIG. 17 is a flowchart illustrating an operation of acquiring sensing data including a rotation angle according to various embodiments.

FIG. 18 is a diagram illustrating an operation of deleting duplicate data based on the number of feature data according to various embodiments.

FIG. 19 is a flowchart illustrating an operation of deleting duplicate data based on the number of feature data according to various embodiments.

FIG. 20 is a diagram illustrating an operation of deleting duplicate data based on whether new feature data is identified according to various embodiments.

FIG. 21 is a flowchart illustrating an operation of deleting duplicate data based on whether new feature data is identified according to various embodiments.

FIG. 22 is a diagram illustrating an operation of deleting duplicate data based on the number of feature data according to various embodiments.

FIG. 23 is a flowchart illustrating an operation of deleting duplicate data based on the number of feature data according to various embodiments.

FIG. 24 is a diagram illustrating an operation of deleting duplicate data based on whether preset feature data is included according to various embodiments.

FIG. 25 is a flowchart illustrating an operation of deleting duplicate data based on whether preset feature data is included according to various embodiments.

FIG. 26 is a diagram illustrating an operation of deleting duplicate data based on a preset location according to various embodiments.

FIG. 27 is a flowchart illustrating an operation of deleting duplicate data based on a preset location according to various embodiments.

FIG. 28 is a diagram illustrating an operation of deleting duplicate data based on feature data corresponding to a plurality of spaces according to various embodiments.

FIG. 29 is a flowchart illustrating an operation of deleting duplicate data based on feature data corresponding to a plurality of spaces according to various embodiments.

FIG. 30 is a diagram illustrating space information according to various embodiments.

FIG. 31 is a diagram illustrating space information according to various embodiments.

FIG. 32 is a flowchart illustrating an operation of acquiring feature data of each of a plurality of spaces according to various embodiments.

FIG. 33 is a diagram illustrating an operation of an electronic device re-recognizing a location according to various embodiments.

FIG. 34 is a flowchart illustrating an operation of an electronic device re-recognizing a location based on a preset event according to various embodiments.

FIG. 35 is a flowchart illustrating an operation of an electronic device re-recognizing a location based on a moving distance of the electronic device according to various embodiments.

FIG. 36 is a flowchart illustrating a method of controlling an electronic device according to various embodiments.

### MODE FOR INVENTION

Hereinafter, the present disclosure will be described in detail with reference to the accompanying drawings.

The terms used in the example embodiments of the present disclosure are general terms which are widely used now and selected considering the functions of the present disclosure. However, the terms may vary depending on the intention of a person skilled in the art, a precedent, or the advent of new technology. In addition, in a specified case, the term may be arbitrarily selected. In this case, the meaning of the term will be explained in the corresponding description. Therefore, terms used in the present disclosure may be defined based on a meaning of the terms and contents described in the present disclosure, not simply based on names of the terms.

As used herein, the expression “have”, “may have”, “include”, or “may include” refers to the existence of a corresponding feature (e.g., numeral, function, operation, or constituent element, such as component), and does not exclude one or more additional features.

The expression of “at least one of A and/or B” is to be understood as indicating any one of “A” or “B” or “A and B”.

The expression “a first”, “a second”, “the first”, or “the second” used in various example embodiments of the disclosure may modify various components regardless of their order and/or the importance but does not limit the corresponding components.

It should be understood that when an element (e.g., first element) is referred to as being (operatively or communicatively) “connected,” or “coupled,” to another element (e.g., second element), it may be directly connected or coupled directly to the other element or another element (e.g., third element) may be interposed between them.

A singular expression includes a plural expression as long as they are clearly distinguished in the context. In the application, it should be understood that the terms, such as “comprising”, “including” are intended to express that features, numbers, steps, operations, constituent elements, part, or combinations thereof described in the specification are present and do not exclude existence or additions of one or more other features, numbers, steps, operations, constituent elements, part, or combinations thereof.

In the description, the word “module” or “unit” refers to a software component, a hardware component, or a combination thereof, which is capable of carrying out at least one function or operation. A plurality of modules or units may be integrated into at least one module and implemented using at least one processor (not shown) except for those modules or units that need to be implemented in specific hardware.

In this disclosure, the term “user” may indicate a person who uses an electronic device or a device (e.g., an artificial intelligence electronic device) that uses an electronic device.

An embodiment of the present disclosure will be described in detail with reference to the accompanying drawings.

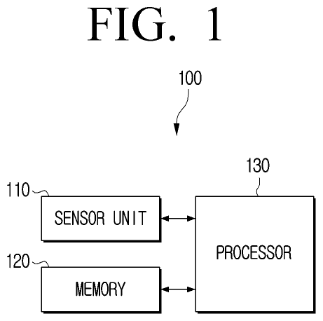

FIG. 1 is a block diagram illustrating an electronic device 100 according to various embodiments.

The electronic device 100 may include at least one of a sensor unit 110, a memory 120, or at least one processor 130.

The electronic device 100 may refer to a mobile electronic device or an electronic device for controlling a mobile device. For example, the electronic device 100 may refer to a mobile robot capable of driving or a device for controlling a mobile robot. In addition, the electronic device 100 may be a server that performs an analysis operation for controlling driving of the device.

According to various embodiments, the electronic device 100 may be a mobile cleaning robot that performs a cleaning operation.

Here, the sensor unit 110 may sense sensing data. The sensor unit 110 may include at least one sensor. Here, at least one sensor may be one of a lidar sensor that senses a location, an image sensor that captures an image, or an acceleration sensor (or a gyro sensor) that senses a rotation angle.

According to various embodiments, one sensor may sense all of the location, the image, the rotation angle, etc.

Here, the memory 120 may store sensing data or processed sensing data. Here, the processed sensing data may be described as mapping data. The memory 120 may store mapping data. In addition, new data may be added to the memory 120 or some data may be deleted from the memory 120.

The processor 130 may perform an overall control operation of the electronic device. Specifically, the processor 130 has a function of controlling the overall operation of the electronic device.

Here, at least one processor 130 may acquire first sensing data including the location of the electronic device 100 and second sensing data including an image captured at the location through the sensor unit 110, acquire map information based on the first sensing data, combine the first sensing data and the second sensing data to acquire first mapping information and store the first mapping information in the memory 120, delete data corresponding to a preset condition from the stored first mapping information to acquire second mapping information, identify space information including feature data corresponding to a space included in the map information based on the second mapping information, and control driving of the electronic device 100 based on the map information and the space information.

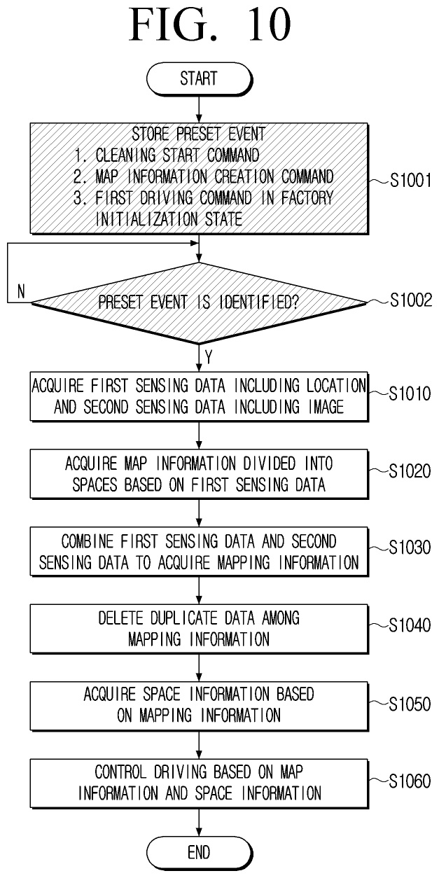

The at least one processor 130 may acquire sensing data according to a preset event. The preset event may include at least one of an event in which a cleaning start command is received, an event in which a map information creation command is received, or an event in which a first driving command is received in a factory initialization state. A specific description related thereto is described in FIG. 10.

Meanwhile, the sensor unit 110 includes a lidar sensor and an image sensor, and the at least one processor 130 may acquire first sensing data through the lidar sensor and acquire second sensing data through the image sensor.

Here, the first sensing data may refer to data related to the location or space of the electronic device 100. The first sensing data may refer to location data or space data. The first sensing data may be data used to analyze the location or space. For example, the first sensing data may be lidar data acquired through the lidar sensor.

Here, the second sensing data may refer to a captured image. The captured image may be used to identify feature data. The at least one processor 130 may extract feature data based on the captured image. Here, the feature data may refer to a feature or object included in the image.

The sensing data may include at least one sensing value. Here, the sensing data may be used in the sense of including a plurality of sensing values and one sensing value.

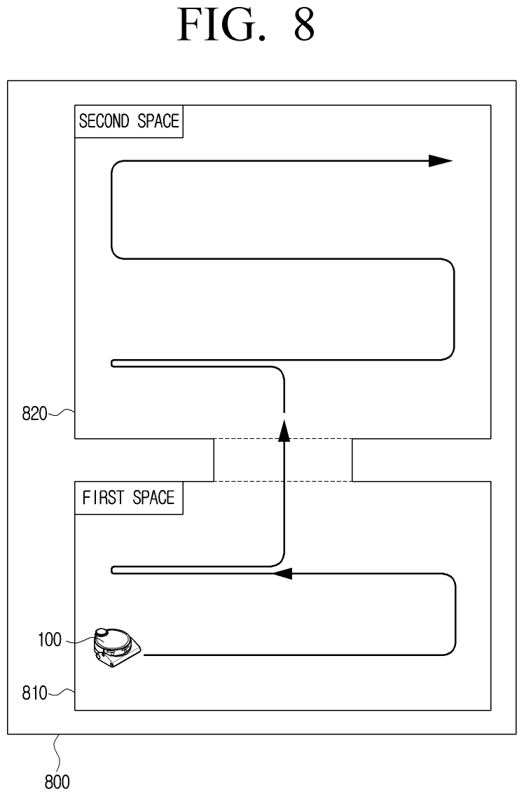

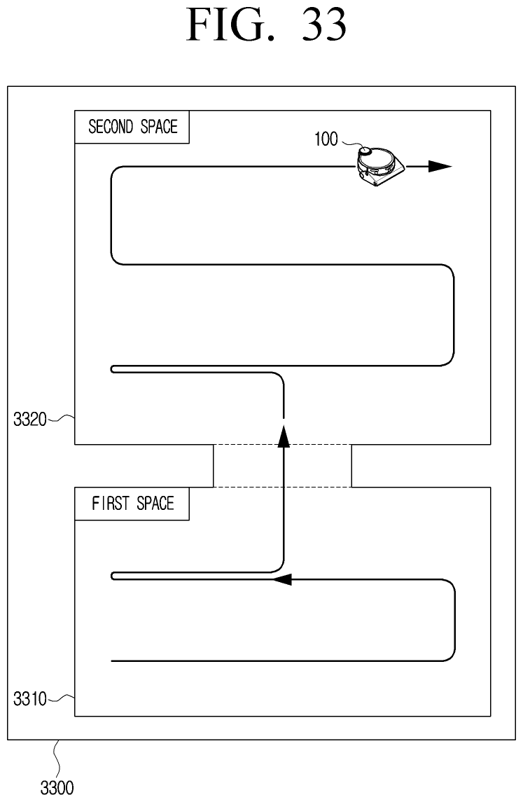

The at least one processor 130 may acquire map information based on the location information included in the first sensing data. Here, the map information may refer to map data used for driving the electronic device 100. A specific description related to the map information is described in FIGS. 8 and 33. The map information may refer to information indicating a space in which the electronic device 100 has to drive.

Meanwhile, the at least one processor 130 may combine the location and image sensed at the same time to acquire first mapping information.

The at least one processor 130 may generate information that may grasp where the captured image was captured. Specifically, the at least one processor 130 may acquire mapping information in which the location information and the image information are combined and stored as one mapping data. The at least one processor 130 may combine the first sensing data and the second sensing data to generate one mapping data. In addition, the at least one processor 130 may store at least one mapping data as mapping information in the memory 120.

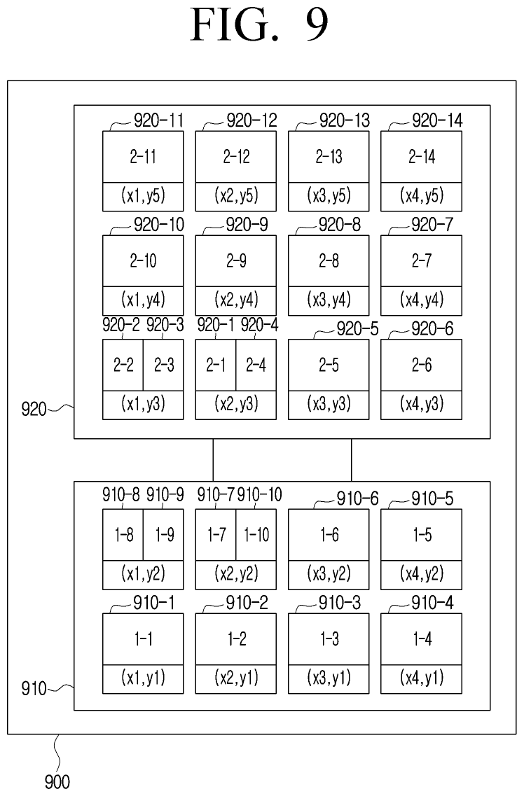

The location information and image information that are the target of mapping may be values sensed at the same time. For example, the at least one processor 130 may combine a first location sensed at a first time point and a first image sensed at the first time point to acquire first mapping data. In addition, the at least one processor 130 may combine a second location sensed at a second time point and a second image sensed at a second time point. In addition, the at least one processor 130 may store first mapping information including the first mapping data and the second mapping data in the memory 120. A specific description related to the mapping data is described in FIG. 9.

Meanwhile, the at least one processor 130 may identify a space based on the map information, acquire feature data corresponding to the space based on an image captured in the space among the second mapping information, and store space information including the feature data corresponding to the space in the memory 120.

Here, the at least one processor 130 may acquire map information through the first sensing data and may identify space information based on the acquired map information. Specifically, the at least one processor 130 may identify whether the entire space may be divided into at least one space. For example, the at least one processor 130 may divide the entire space into two spaces based on the map information.

The at least one processor 130 may acquire feature data of the identified (or divided) space. The at least one processor 130 may extract feature data of the space based on an image included in the second sensing data.

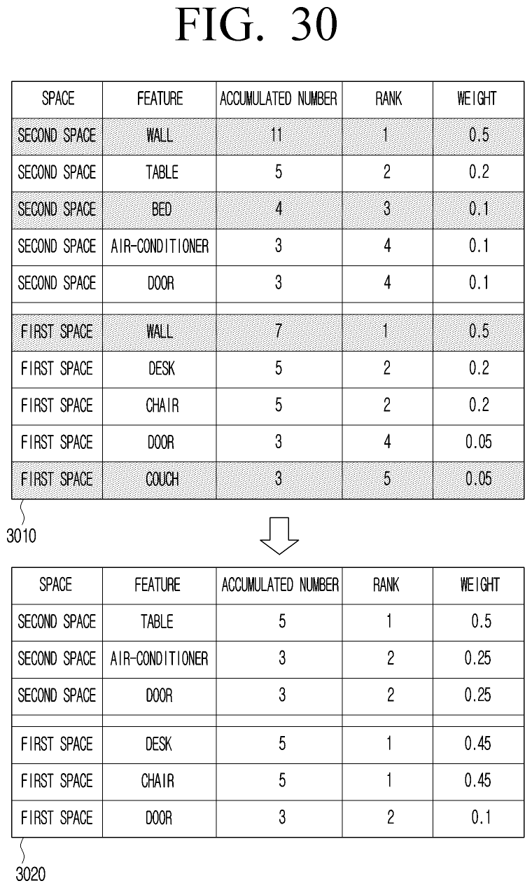

The at least one processor 130 may acquire feature data corresponding to each of a plurality of spaces. For example, the at least one processor 130 may acquire feature data corresponding to the first space and feature data corresponding to the second space. In addition, the at least one processor 130 may store space information including feature data for each space in the memory 120. Specific descriptions related thereto are described in FIGS. 30 to 32.

Meanwhile, when a preset event is identified, the at least one processor 130 may identify the location of the electronic device 100 based on the map information and space information, and the preset event may include at least one of an event in which the electronic device 100 moves by a threshold distance or greater, an event in which driving is terminated, or an event in which a user command is received during driving.

The at least one processor 130 may perform a location re-recognition operation according to the preset event.

The event in which the electronic device 100 moves by the threshold distance or greater may indicate a situation in which a distance by which the electronic device 100 has moved during a preset time is equal to or greater than a threshold distance. For example, a user may artificially move the location of the electronic device 100. The event in which driving is terminated may indicate a situation in which driving is completed and the electronic device 100 returns to a charging location. The event in which a user command is received during driving may indicate a situation in which the electronic device 100 has to move to a new location for new driving.

Specific descriptions related thereto are described in FIGS. 33 to 35.

Meanwhile, when a user input for driving the electronic device 100 is received, the at least one processor 130 may acquire first sensing data and second sensing data while driving corresponding to the user input is performed, and when the driving is terminated, data corresponding to a preset condition in the first mapping information may be deleted to acquire second mapping information.

Here, the at least one processor 130 may identify data corresponding to a preset condition corresponding to a repeated image. Here, the data corresponding to the preset condition may be described as duplicate data or unnecessary (redundant) data.

Here, the preset condition may refer to at least one of data having a similar location, data having a similar rotation angle, data having a similar sensing time, data having the number of extracted features less than or equal to a threshold number, data from which preset feature data is extracted, or data acquired at a specific location.

Therefore, “data corresponding to a preset condition” may be interpreted as “duplicate data corresponding to a repeated image.” In addition, the expression “repeated” itself does not necessarily refer to that the image is identical but may refer to that the image itself is unnecessary data or meaningless data to the user, in addition to the image itself being similar.

Hereinafter, data corresponding to a preset condition is described as duplicate data. However, duplicate data should not be interpreted as meaning repeated data, and duplicate data may refer to data corresponding to a preset condition. In other words, duplicate data may be a concept that includes data corresponding to a preset condition and unnecessary data.

If the expression “repeated image” should be interpreted as an image itself being similar, the operation of deleting duplicate data may be performed in a plurality of stages. For example, after deleting data with similar images, at least one of data having the number of extracted features less than or equal to a threshold number, data from which preset feature data is extracted, or data acquired at a specific location may be additionally deleted as duplicate data.

When a user input for performing cleaning is received, the at least one processor 130 may perform cleaning on the entire space. In addition, the at least one processor 130 may acquire sensing data while performing cleaning. In addition, the at least one processor 130 may newly create or update map information based on the acquired sensing data. When the map information is created or updated, the at least one processor 130 may delete some of the sensing data as duplicate data. This is because the sensing data includes an image and thus takes up a lot of memory storage capacity.

The first mapping information may refer to information before the duplicate data is deleted. The second mapping information may refer to information after the duplicate data is deleted.

Meanwhile, the first mapping information includes a plurality of mapping data, and the at least one processor 130 may identify duplicate data among the plurality of mapping data based on at least one of the location, sensing time, or rotation angle.

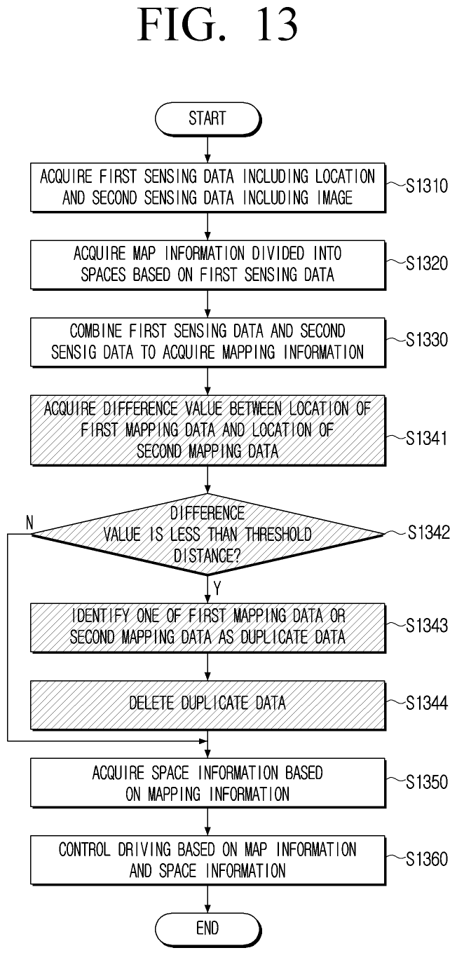

Meanwhile, according to various embodiments, the at least one processor 130 may identify duplicate data based on a location difference value. The first mapping information includes the first mapping data and the second mapping data, and if a difference value between a location of the first mapping data and a location of the second mapping data is less than a threshold distance, the at least one processor 130 may identify one of the first mapping data or the second mapping data as duplicate data. A specific description related thereto is described in FIG. 13.

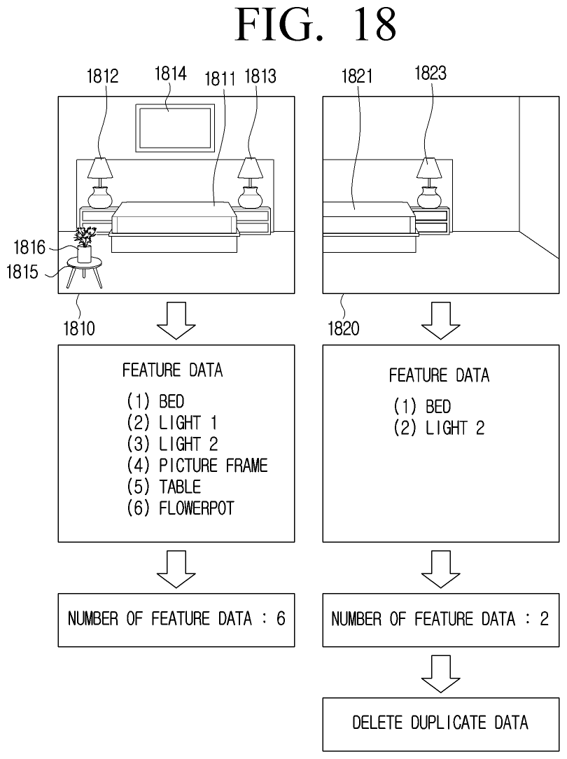

According to various embodiments, the at least one processor 130 may identify a plurality of duplicate data and delete some data among the identified duplicate data. In relation to the operation of selecting some data, the at least one processor 130 may delete initially sensed data, delete data sensed later, compare the number of feature data, or determine whether new feature data is included. Specific descriptions related thereto are described in FIGS. 18 to 21.

According to various embodiments, the at least one processor 130 may identify duplicate data among a plurality of mapping data and delete all identified duplicate data.

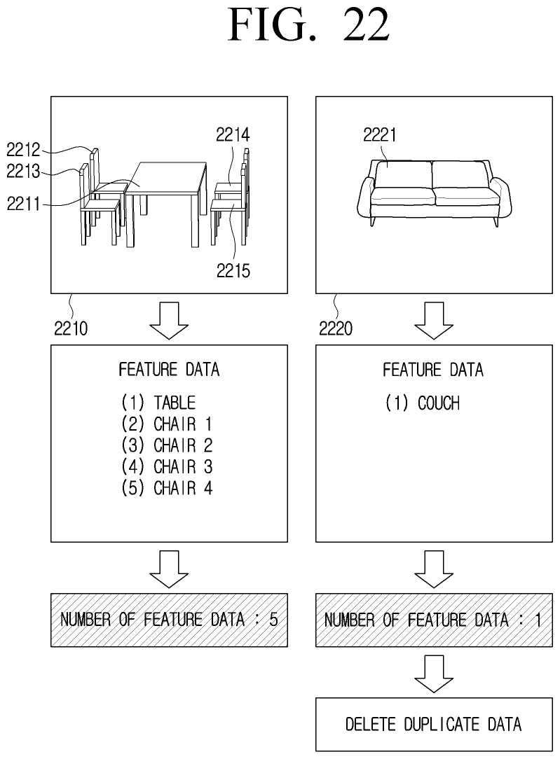

Meanwhile, the first mapping information may include a plurality of mapping data, and the at least one processor 130 may identify duplicate data among a plurality of mapping data in at least one of the number of feature data or preset feature data. Specific descriptions related thereto are described in FIGS. 22 to 25.

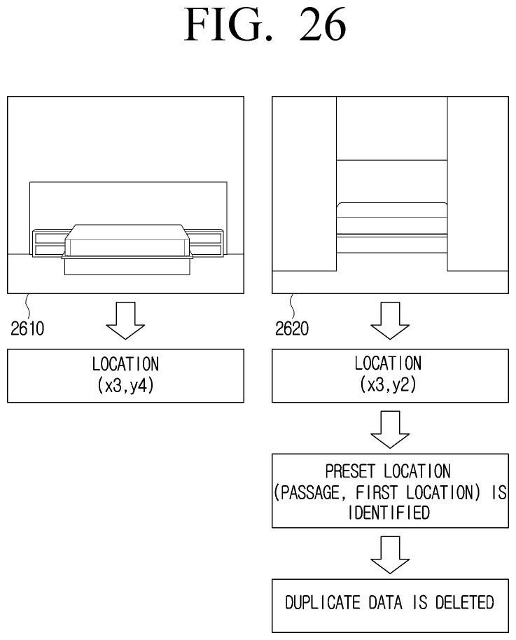

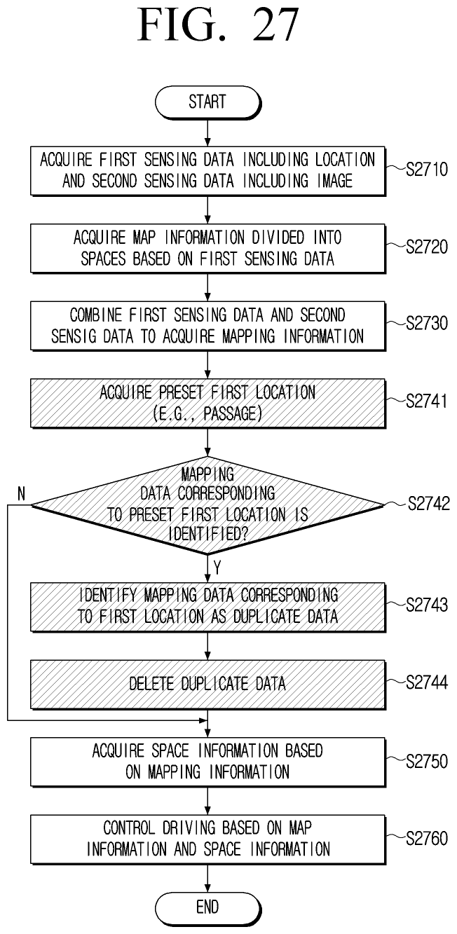

Meanwhile, according to various embodiments, the at least one processor 130 may identify duplicate data based on a preset location. The at least one processor 130 may identify mapping data corresponding to a preset location among a plurality of mapping data as duplicate data. Here, the preset location may refer to a location that a user considers unimportant. Specific descriptions related thereto are described in FIGS. 26 and 27.

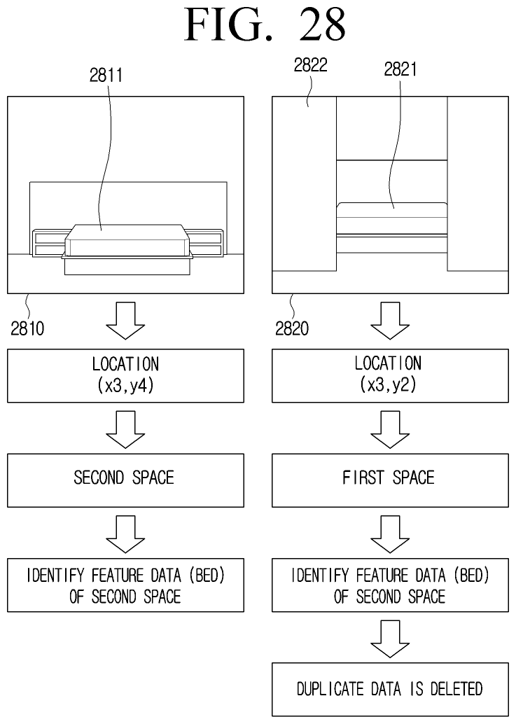

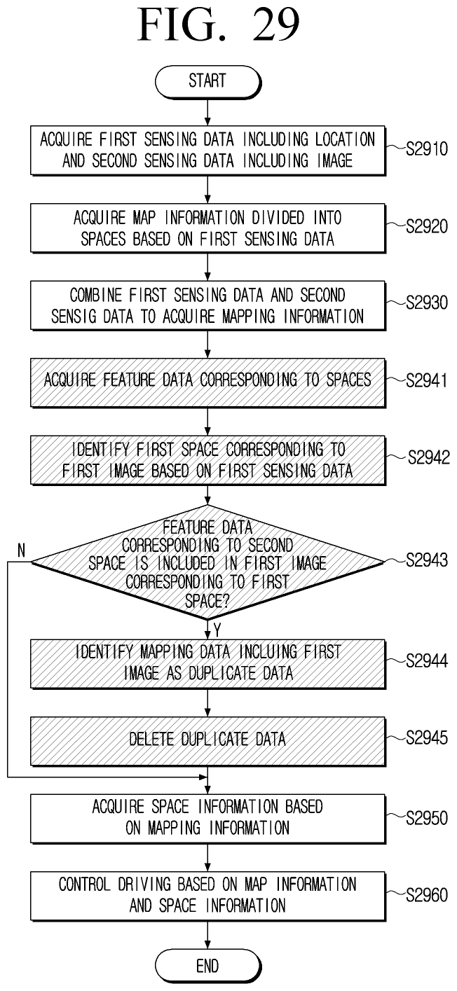

Meanwhile, according to various embodiments, the at least one processor 130 may identify duplicate data based on a preset location and preset feature data. Here, the preset feature data may refer to features that the user considers unimportant. A specific description related thereto is described in FIGS. 28 and 29.

According to various embodiments, the electronic device 100 may control the driving of the electronic device 100 by using both location information and image information. Specifically, the electronic device 100 may additionally use the image information in addition to the location information in a situation in which the location is re-recognized. Therefore, the electronic device 100 may maintain high accuracy when re-recognizing the location.

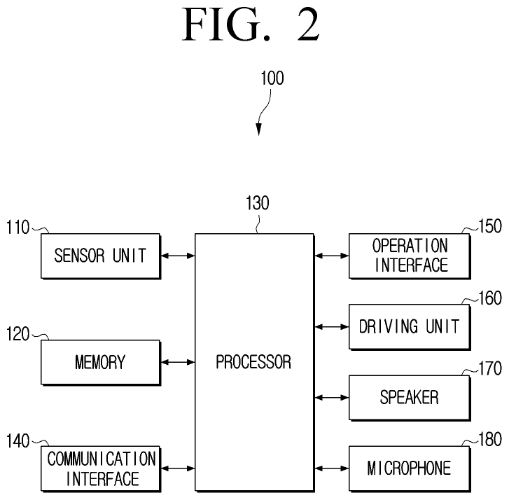

Meanwhile, although only a simple configuration of the electronic device 100 is illustrated and described above, various components may be additionally provided during implementation. This will be described below with reference to FIG. 2.

FIG. 2 is a block diagram illustrating a specific configuration of the electronic device 100 of FIG. 1.

Referring to FIG. 2, the electronic device 100 may include at least one of the sensor unit 110, the memory 120, the at least one processor 130, a communication interface 140, an operation interface 150, a driving unit 160, a speaker 170, or a microphone 180.

Meanwhile, for the operations of the sensor unit 110, the memory 120, and the at least one processor 130, the same operations as those described above will be omitted.

The memory 120 may be implemented as an internal memory, such as a read-only memory (ROM) (e.g., an electrically erasable programmable read-only memory (EEPROM)) or a random-access memory (RAM) included in the processor 130 or may be implemented as a separate memory from the processor 130. In this case, the memory 120 may be implemented as a memory embedded in the electronic device 100 or as a memory that may be detachably attached to the electronic device 100 depending on the purpose of data storage. For example, data for driving the electronic device 100 may be stored in a memory embedded in the electronic device 100, and data for expanding functions of the electronic device 100 may be stored in a memory that may be detachably attached to the electronic device 100.

Meanwhile, a memory embedded in the electronic device 100 may be implemented as at least one of volatile memory (e.g., dynamic RAM (DRAM), static RAM (SRAM), or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)), and a memory that may be detachably attached to the electronic device 100 may be implemented in the form of a memory card (e.g., compact flash (CF), secure digital (SD), micro SD, mini SD, extreme digital (xD), multi-media card (MMC), etc.), external memory that may be connected to a USB port (e.g., USB memory), etc.

The processor 130 may be implemented as a digital signal processor (DSP), a microprocessor, or a time controller (TCON) that processes digital signals. However, without being limited thereto, the processor 130 may include one or more of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machines (ARM) processor or may be defined by the corresponding term. In addition, the processor 130 may be implemented as a system on chip (SoC), a large scale integration (LSI) with a built-in processing algorithm or may be implemented in the form of a field programmable gate array (FPGA). In addition, the processor 130 may perform various functions by executing computer executable instructions stored in a memory.

The communication interface 140 is a component that performs communication with various types of external devices according to various types of communication methods. The communication interface 140 may include a wireless communication module or a wired communication module. Here, each communication module may be implemented in the form of at least one hardware chip.

The wireless communication module may be a module that wirelessly communicates with an external device. For example, the wireless communication module may include at least one module among a Wi-Fi module, a Bluetooth module, an infrared communication module, or other communication modules.

The Wi-Fi module and the Bluetooth module may perform communication in a Wi-Fi method and the Bluetooth method, respectively. In the case of using the Wi-Fi module or the Bluetooth module, various connection information, such as a service set identifier (SSID) and a session key may be first transmitted and received, communication may then be connected using the connection information, and then various information may be transmitted and received.

The infrared communication module performs communication according to infrared communication (infrared Data Association (IrDA)) technology that wirelessly transmits data over a short distance using infrared rays present between visible light and millimeter waves.

Other communication modules may include at least one communication chip that performs communication according to various wireless communication standards, such as Zigbee, 3rd Generation (3G), 3rd Generation Partnership Project (3GPP), long term evolution (LTE), LTE Advanced (LTE-A), 4th Generation (4G), 5th Generation (5G), etc. in addition to the aforementioned communication methods.

The wired communication module may be a module that communicates with an external device through a wire. For example, the wired communication module may include at least one of a local region network (LAN) module, an Ethernet module, a pair cable, a coaxial cable, an optical fiber cable, or a ultra wide-band (UWB) module.

The operation interface 150 may be implemented as a device, such as a button, a touch pad, a mouse, and a keyboard, or may be implemented as a touch screen that may also perform the aforementioned display function and operation input function. Here, the button may be various types of buttons, such as a mechanical button, a touch pad, a wheel, etc. formed in any region of a front portion, a side portion, or a rear portion of a main body of the electronic device 100.

The driving unit 160 may be a component that generates and transmits a physical force that controls the driving of the electronic device 100. The driving unit 160 may include a motor.

The speaker 170 may be a component that outputs various audio data as well as various notification sounds or voice messages.

The electronic device 100 may include the microphone 180.

The microphone 180 is a component that receives a user's voice or other sounds and converts the same into audio data. The microphone 180 may receive the user's voice in an activated state. For example, the microphone 180 may be formed integrally on an upper side, a front surface direction, or side surface direction of the electronic device 100. The microphone 180 may include various configurations, such as a microphone that collects user voice in analog form, an amplifier circuit that amplifies the collected user voice, an A/D conversion circuit that samples the amplified user voice and converts the same into a digital signal, and a filter circuit that removes noise components from the converted digital signal.

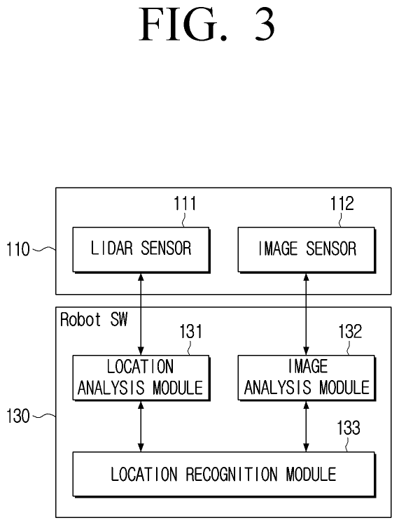

FIG. 3 is a view illustrating a location recognition module included in the electronic device 100.

Referring to FIG. 3, the electronic device 100 may include the sensor unit 110 and the processor 130. Here, the sensor unit 110 may include at least one of a first sensor 111 or a second sensor 112.

Here, the first sensor 111 may be a sensor that senses data for analyzing space or location. For example, the first sensor 111 may be a lidar sensor.

Here, the second sensor 112 may be a sensor that senses data for analyzing an image. For example, the second sensor 112 may be an image sensor.

Here, the processor 130 may include at least one of a location analysis module 131, an image analysis module 132, or a location recognition module 133.

Here, the location analysis module 131 may analyze the location of the electronic device 100 or the space in which the electronic device 100 is located based on first sensing data acquired through the first sensor 111. The analyzed result data may be described as first result data.

Here, the image analysis module 132 may acquire feature data included in a captured image based on the second sensing data acquired through the second sensor 112. The analyzed result data may be described as second result data.

Here, the location recognition module 133 may recognize (or identify) the location of the electronic device 100 based on the first result data acquired through the location analysis module 131 and the second result data acquired through the image analysis module 132.

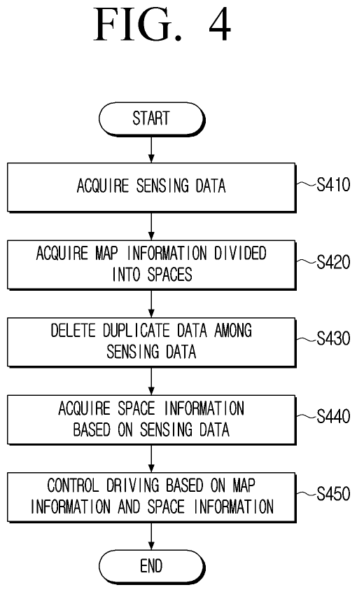

FIG. 4 is a flowchart illustrating an operation of deleting duplicate data from sensing data according to various embodiments.

Referring to FIG. 4, the electronic device 100 may acquire sensing data (S410). Here, the electronic device 100 may acquire at least one sensing data through the sensor unit. The electronic device 100 may acquire map information divided into a plurality of spaces (S420). The electronic device 100 may analyze a driving space of the electronic device 100 based on the sensing data. The electronic device 100 may set the entire map based on the sensing data and divide the entire map into a plurality of spaces. The electronic device 100 may acquire map information including information related to the driving space.

Here, the electronic device 100 may delete duplicate data in the acquired sensing data (S430). The electronic device 100 may acquire space information based on the sensing data (S440). Here, the space information may include feature data (or a feature object) corresponding to the space.

Here, the electronic device 100 may control driving of the electronic device 100 based on the map information and the space information (S450). Controlling the driving of the electronic device 100 may refer to determining a driving path or driving mode of the electronic device 100.

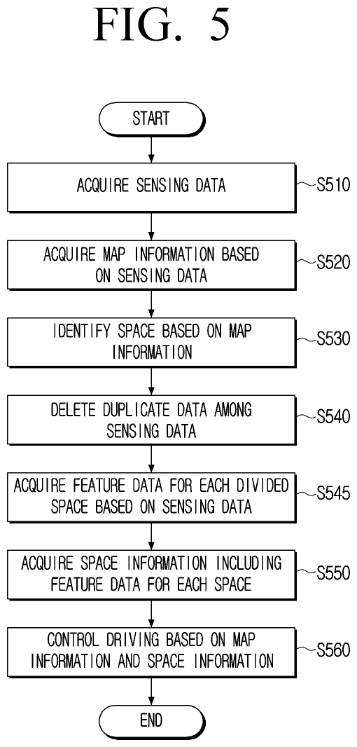

FIG. 5 is a flowchart that embodies the operation of FIG. 4.

Referring to FIG. 5, the electronic device 100 may acquire sensing data (S510). The electronic device 100 may acquire map information based on the sensing data (S520). Here, the map information may include information for identifying the driving space of the electronic device 100. The electronic device 100 may divide a space based on the map information (S530). The electronic device 100 may acquire the map information divided into a plurality of spaces.

Here, the electronic device 100 may delete duplicate data among the sensing data (S540). The electronic device 100 may acquire feature data for each divided space based on the sensing data (S545). The sensing data used to acquire the feature data may refer to data from which duplicate data has been deleted.

For example, the electronic device 100 may acquire a first sensing data group. The electronic device 100 may delete duplicate data from the first sensing data group to acquire a second sensing data group. Here, the electronic device 100 may acquire feature data for each space based on the second sensing data group.

Here, the electronic device 100 may acquire space information including feature data for each space (S550). The electronic device 100 may control the driving of a projection image based on the map information and the space information.

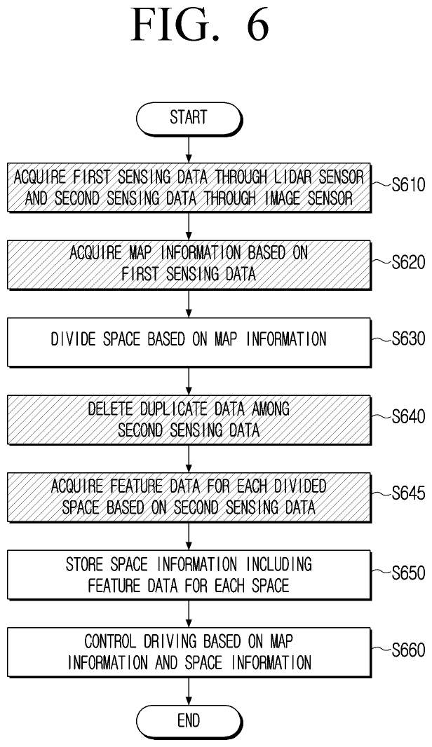

FIG. 6 is a flowchart illustrating an operation of deleting duplicate data from sensing data acquired through a plurality of sensors.

Operations S630, S650, and S660 of FIG. 6 may correspond to operations S530, S550, and S560 of FIG. 5. Therefore, a redundant description is omitted.

The electronic device 100 may acquire first sensing data through a lidar sensor and second sensing data through an image sensor (S610). The electronic device 100 may acquire map information based on the first sensing data (S620).

The electronic device 100 may divide a space based on the map information (S630). Also, the electronic device 100 may delete duplicate data based on the second sensing data (S640). The electronic device 100 may acquire feature data for each divided space based on the second sensing data (S645).

Thereafter, the electronic device 100 may perform operations S650 and S660.

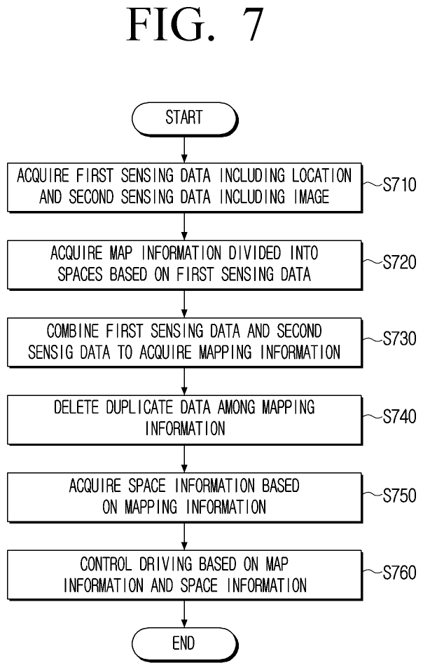

FIG. 7 is a flowchart illustrating an operation of controlling driving based on sensing data according to various embodiments.

Referring to FIG. 7, the electronic device 100 may acquire first sensing data including a location and second sensing data including an image (S710).

According to various embodiments, the first sensing data and the second sensing data may be data acquired from different sensors. For example, the first sensing data may be data acquired through the first sensor 111. Here, the second sensing data may be data acquired through the second sensor 112.

According to various embodiments, the first sensing data and the second sensing data may be data acquired from one sensor. Here, the sensor may sense data including a location and an image.

Here, the electronic device 100 may acquire map information divided into a plurality of spaces based on the first sensing data (S720). The electronic device 100 may divide the entire space data into a plurality of spaces. Here, the plurality of spaces may be divided based on an outline (or boundary line) identified in the sensing data.

Here, the electronic device 100 may combine the first sensing data and the second sensing data to acquire mapping information (S730). The electronic device 100 may acquire mapping information in which a location and an image are mapped.

Here, the electronic device 100 may delete duplicate data among the mapping information (S740). The electronic device 100 may identify some data among the plurality of mapping information as duplicate data. Also, the electronic device 100 may delete the data identified as duplicate data.

Here, the electronic device 100 may acquire space information based on the mapping information (S750). Here, the space information may include feature data for representing a space.

Here, the electronic device 100 may control driving based on the map information and the space information (S760). The electronic device 100 may control driving of the electronic device 100 based on the map information representing the location and the space information representing the feature of each space. Specifically, the electronic device 100 may re-recognize the location based on the map information and the space information.

FIG. 8 is a view illustrating a driving path of the electronic device 100.

Referring to FIG. 8, the electronic device 100 may acquire the entire map data 800. Here, the entire map data 800 may be included in the map information. The entire map data 800 may be divided into a first space 810 and a second space 820 based on an outline. The electronic device 100 may drive from a specific location in the first space to a specific location in the second space.

FIG. 9 is a view illustrating mapping data.

Referring to FIG. 9, the electronic device 100 may acquire entire map data 900 representing a first space 910 and a second space 920.

The electronic device 100 may acquire first sensing data and second sensing data according to a driving path. Also, the first sensing data and the second sensing data sensed at the same time may be mapped. Here, the first sensing data may include a location, and the second sensing data may include an image.

The mapping data may be data obtained by combining the location and the image sensed at the same time. The electronic device 100 may acquire mapping data 910-1, 910-2, 910-3, 910-4, 910-5, 910-6, 910-7, 910-8, 910-9, and 910-10 in the first space 910. In addition, the electronic device 100 may acquire mapping data 920-1, 920-2, 920-3, 920-4, 920-5, 920-6, 920-7, 920-8, 920-9, 920-10, 920-11, 920-12, 920-13, and 920-14 in the second space 920.

FIG. 10 is a flowchart illustrating an operation of acquiring mapping data according to various embodiments.

S1010, S1020, S1030, S1040, S1050, and S1060 of FIG. 10 may correspond to S710, S720, S730, S740, S750, and S760 of FIG. 7. Therefore, a redundant description is omitted.

The electronic device 100 may store a preset event (S1001). Here, the preset event may include at least one of an event in which a cleaning start command is received, an event in which a map information creation command is received, or an event in which a first driving command is received in a factory initialization state.

The electronic device 100 may determine whether a preset event is identified (S1002). The electronic device 100 may receive a user command corresponding to the preset event. If the preset event is not identified (S1002—N), the electronic device 100 may repeatedly receive the user command. If the preset event is identified (S1002—Y), the electronic device 100 may perform operations S1010 to S1060.

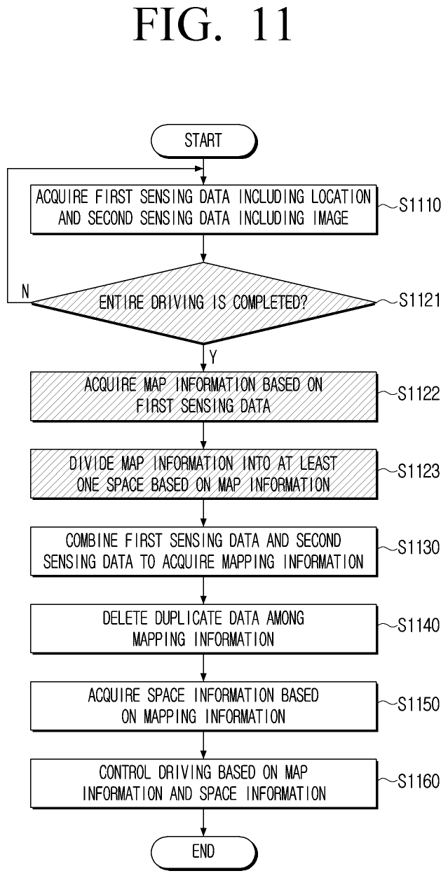

FIG. 11 is a flowchart illustrating an operation of dividing a space based on map information.

S1110, S1130, S1140, S1150, and S1160 of FIG. 11 may correspond to S710, S730, S740, S750, and S760 of FIG. 7. Therefore, a redundant description is omitted.

After the first sensing data and the second sensing data are acquired, the electronic device 100 may determine whether the entire driving is completed (S1121). If the entire driving is not completed (S1121—N), the electronic device 100 may repeat operations S1110 and S1121.

When the entire driving is completed (S1121—Y), the electronic device 100 may acquire map information based on the first sensing data (S1122). Also, the electronic device 100 may divide the map information (or map data) into at least one space (S1123). The electronic device 100 may divide the entire space into a plurality of spaces based on the outline of the map data. If only one space is identified, the electronic device 100 may not perform the operation of dividing the entire space into a plurality of spaces.

Thereafter, the electronic device 100 may perform operations S1130 to S1160.

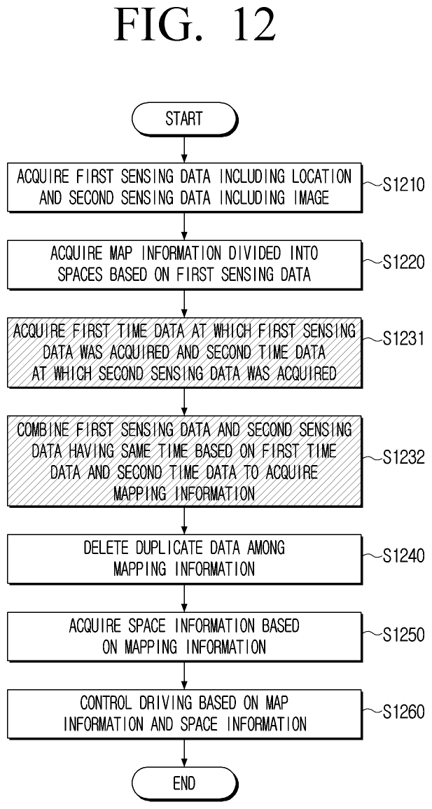

FIG. 12 is a flowchart illustrating an operation of acquiring mapping information using time data.

S1210, S1220, S1240, S1250, and S1260 of FIG. 12 may correspond to S710, S720, S740, S750, and S760 of FIG. 7. Therefore, a redundant description is omitted.

After acquiring map information, the electronic device 100 may acquire first time data at which the first sensing data was acquired and second time data at which the second sensing data was acquired (S1231). Here, the time data may refer to the time at which the sensing data is acquired through the sensor unit.

Here, the electronic device 100 may combine first sensing data and second sensing data having the same time based on the first time data and the second time data to acquire mapping information (S1232). Specifically, the electronic device 100 may combine the first sensing data and the second sensing data having the same sensed time to acquire mapping information. One mapping data included in the mapping information may include a first location of the electronic device 100 sensed at the same time and a first image captured at the first location.

Thereafter, the electronic device 100 may perform operations S1240 to S1260.

FIG. 13 is a flowchart illustrating an operation of deleting duplicate data based on a threshold distance.

S1310, S1320, S1330, S1350, and S1360 of FIG. 13 may correspond to S710, S720, S730, S750, and S760 of FIG. 7. Therefore, a redundant description is omitted.

After acquiring the mapping information, the electronic device 100 may acquire a difference value between the location of the first mapping data and the location of the second mapping data (S1341). Here, the first mapping data may include first sensing data acquired at a first time point and second sensing data acquired at the first time point. Here, the second mapping data may include first sensing data acquired at a second time point and second sensing data acquired at a second time point. The electronic device 100 may acquire a difference value between the location sensed at the first time point and the location sensed at the second time point.

Here, the electronic device 100 may identify whether the difference value is less than a threshold distance (S1342). If the difference value is less than the threshold distance (S1342—Y), the electronic device 100 may identify one of the first mapping data or the second mapping data as duplicate data (S1343). The electronic device 100 may determine data acquired at a close distance as duplicate data. Then, the electronic device 100 may delete the duplicate data (S1344). Thereafter, the electronic device 100 may perform operations S1350 to S1360.

If the difference value is not less than the threshold distance (S1342—N), the electronic device 100 may perform operations S1350 to S1360, without deleting duplicate data.

In FIG. 13, the location and the threshold distance are described, but according to various embodiments, the electronic device 100 may delete duplicate data by applying time and the threshold time.

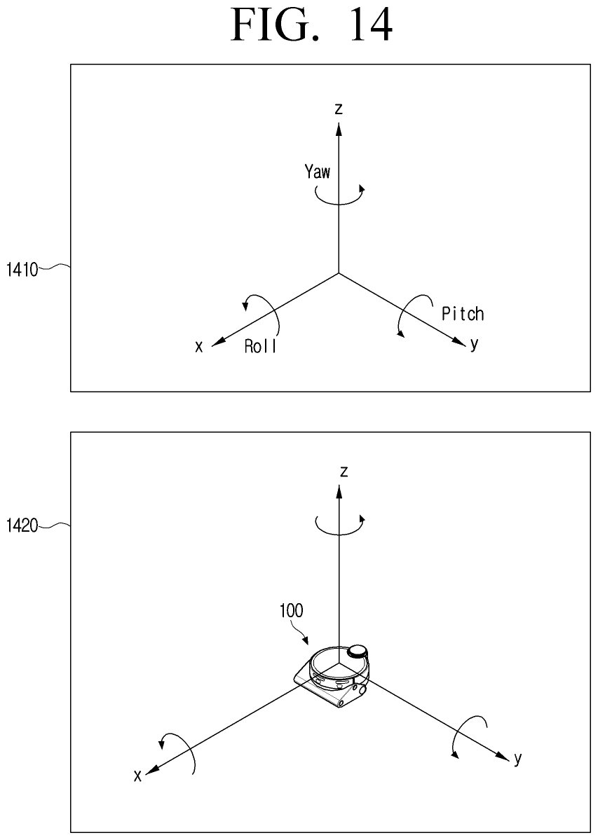

FIG. 14 is a view illustrating rotation angles of the electronic device 100.

An embodiment 1410 of FIG. 14 is a graph defining rotation directions according to the x, y, and z axes. Rotation based on the x-axis may be defined as roll, rotation based on the y-axis may be defined as pitch, and rotation based on the z-axis may be defined as yaw.

In an embodiment 1420 of FIG. 14, a rotation direction of the electronic device 100 may be described as a rotation direction defined in the embodiment 1010. X-axis rotation information of the electronic device 100 may correspond to a roll that rotates based on the x-axis of the electronic device 100. Y-axis rotation information of the electronic device 100 may correspond to a pitch that rotates based on the y-axis of the electronic device 100. Z-axis rotation information of the electronic device 100 may correspond to a yaw that rotates based on the z-axis of the electronic device 100.

Meanwhile, the x-axis rotation information may be described as first-axis rotation information, first-axis tilt information, or horizontal distortion information. In addition, the y-axis rotation information may be described as second-axis rotation information, second-axis tilt information, or vertical tilt information. In addition, the z-axis rotation information may be described as third-axis rotation information, third-axis tilt information, or horizontal tilt information.

Meanwhile, the sensor unit 110 may acquire state information (or tilt information) of the electronic device 100. Here, the state information of the electronic device 100 may refer to a rotation state of the electronic device 100. Here, the sensor unit 110 may include at least one of a gravity sensor, an acceleration sensor, or a gyro sensor. The x-axis rotation information of the electronic device 100 and the y-axis rotation information of the electronic device 100 may be determined based on sensing data acquired through the sensor unit 110.

Meanwhile, the z-axis rotation information may be acquired based on how much the electronic device 100 has rotated according to its movement.

According to various embodiments, the z-axis rotation information may indicate how much the electronic device 100 has rotated along the z-axis for a preset time. For example, the z-axis rotation information may indicate how much the electronic device 100 has rotated along the z-axis at a second time point based on a first time point.

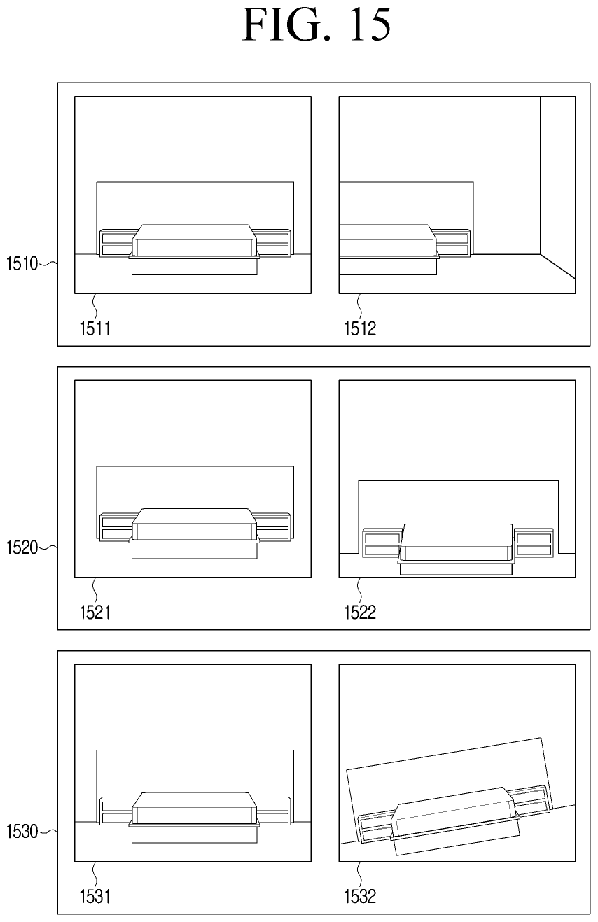

FIG. 15 is a view illustrating an image acquired according to a rotation angle of the electronic device 100.

An embodiment 1510 of FIG. 15 illustrates an image 1511 captured at a first location and an image 1512 captured by rotating around the z-axis (rotated in the yaw direction) at the first location. The captured images may be partially different as the electronic device 100 rotates around the z-axis.

An embodiment 1520 of FIG. 15 illustrates an image 1521 captured at the first location and an image 1522 captured by rotating around the y-axis (rotated in the pitch direction) at the first location. The captured images may be partially different as the electronic device 100 rotates around the y-axis.

An embodiment 1530 of FIG. 15 illustrates an image 1531 captured at the first location and an image 1532 captured by rotating around the x-axis (rotated in the roll direction) at the first location. The captured images may be partially different as the electronic device 100 rotates around the x-axis.

The electronic device 100 may sense a rotation angle and identify data whose rotation angle is within a critical angle as duplicate data. Then, the electronic device 100 may delete the duplicate data.

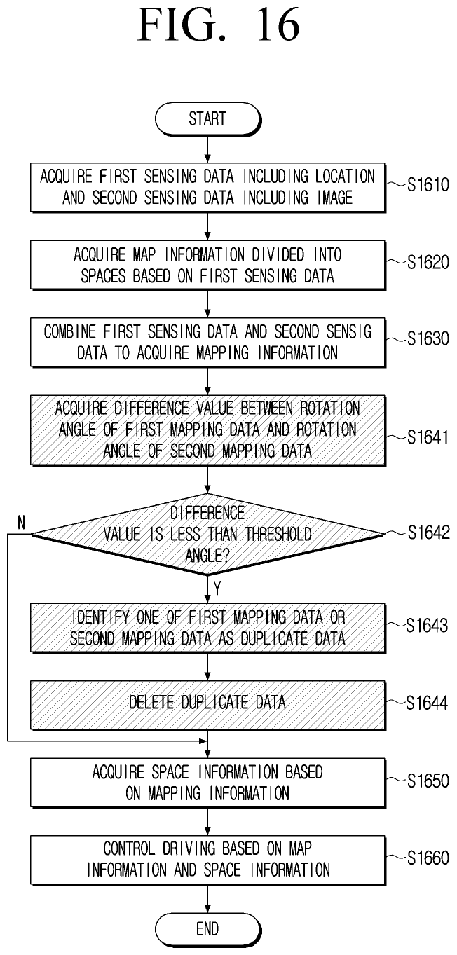

FIG. 16 is a flowchart illustrating an operation of deleting duplicate data based on a critical angle.

S1610, S1620, S1630, S1650, and S1660 of FIG. 16 may correspond to S710, S720, S730, S750, and S760 of FIG. 7. Therefore, a redundant description is omitted.

After acquiring the mapping information, the electronic device 100 may acquire a difference value between a rotation angle of the first mapping data and a rotation angle of the second mapping data (S1641). The mapping data may include first sensing data including a location. Here, the first sensing data may include information on the rotation angle. Therefore, the electronic device 100 may acquire information on the rotation angle based on the first sensing data.

Here, the electronic device 100 may identify whether the acquired difference value is less than the critical angle (S1642). If the difference value is less than the critical angle (S1642—Y), the electronic device 100 may identify one of the first mapping data and the second mapping data as duplicate data (S1643). Then, the electronic device 100 may delete the duplicate data. Thereafter, the electronic device 100 may perform operations S1630 to S1660.

If the difference value is not less than the critical angle (S1642—N), the electronic device 100 may perform operations S1650 to S1660, without deleting the duplicate data.

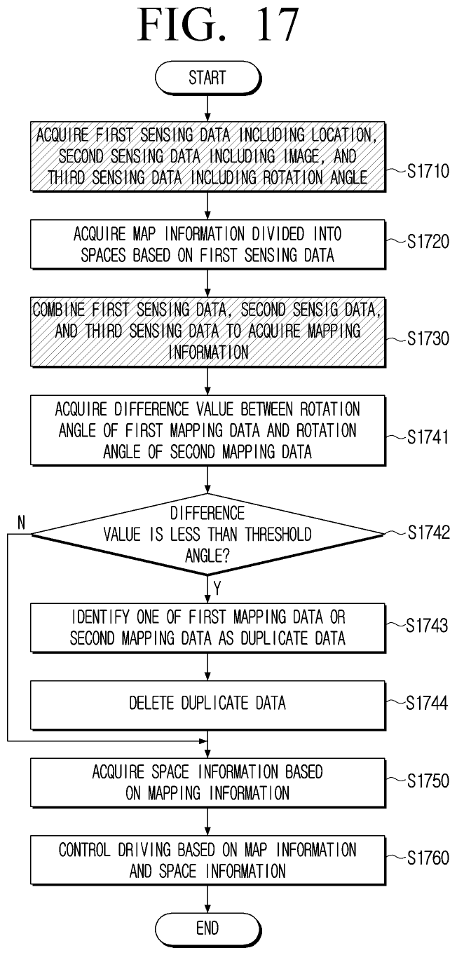

FIG. 17 is a flowchart illustrating an operation of acquiring sensing data including a rotation angle.

Operations S1720, S1741, S1742, S1743, S1744, S1750, and S1760 of FIG. 17 may correspond to operations S1620, S1641, S1642, S1643, S1644, S1650, and S1660 of FIG. 16. Therefore, a redundant description may be omitted.

The electronic device 100 may acquire first sensing data including a location, second sensing data including an image, and third sensing data including a rotation angle (S1710). Here, the third sensing data may be sensing data acquired through a third sensor (not shown). Here, the third sensor (not shown) may refer to an acceleration sensor or a gyro sensor.

After acquiring map information, the electronic device 100 may combine the first sensing data, the second sensing data, and the third sensing data to acquire mapping information (S1730). Here, the mapping information may additionally include information on a rotation angle in addition to the location and the image.

Thereafter, the electronic device 100 may perform operations S1741 to S1760.

FIG. 18 is a diagram illustrating an operation of deleting duplicate data based on the number of feature data according to various embodiments.

Referring to FIG. 18, the electronic device 100 may acquire feature data included in a first image 1810 and feature data included in a second image 1820.

A first image 1810 may include a bed object 1811, a first light object 1812, a second light object 1813, a picture frame object 1814, a table object 1815, and a flowerpot object 1816.

The second image 1820 may include a bed object 1821 and a second light object 1823.

Here, the bed object 1811 and the bed object 1821 may be the same object. In addition, the second light object 1813 and the second light object 1823 may be the same object.

The electronic device 100 may acquire feature data based on the first image 1810. Here, the electronic device 100 may acquire a plurality of objects as feature data. The electronic device 100 may identify the number of feature data (e.g., 6) of the first image 1810.

The electronic device 100 may acquire feature data based on the second image 1820. Here, the electronic device 100 may acquire a plurality of objects as feature data. The electronic device 100 may identify the number of feature data (e.g., 2) of the second image 1820.

Here, the electronic device 100 may identify the second image 1820 with a smaller number of feature data. Then, the electronic device 100 may delete the mapping data including the second image 1820.

Meanwhile, in FIG. 18, it is described that one feature data is extracted (or acquired) from one object. According to various embodiments, the electronic device 100 may acquire two or more feature data for one object. For example, the electronic device 100 may acquire first feature data representing a bed and second feature data representing a region that cannot be cleaned based on a bed object. In addition, the electronic device 100 may acquire first feature data representing light 1, second feature data representing an LED light, and third feature data representing danger when approaching based on the light 1 object.

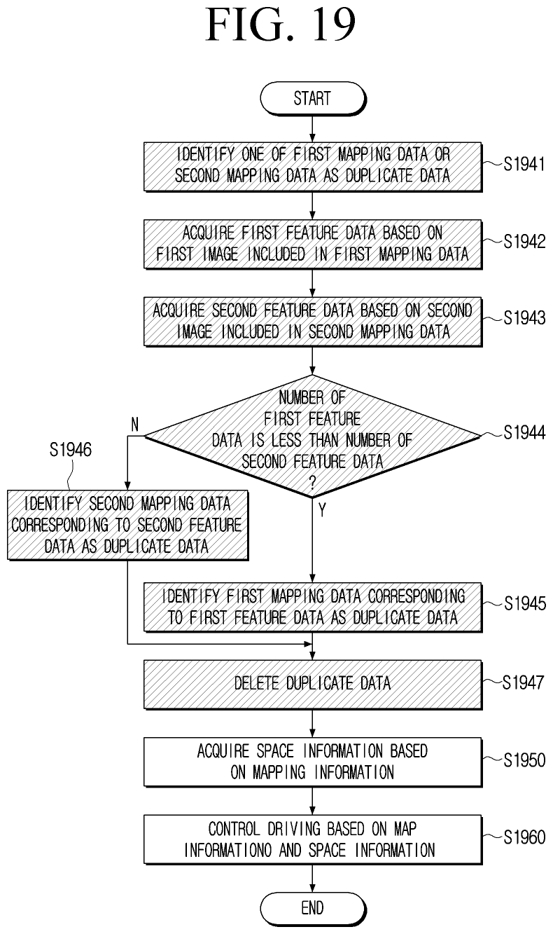

FIG. 19 is a flowchart illustrating an operation of deleting duplicate data based on the number of feature data according to various embodiments.

Referring to FIG. 19, the electronic device 100 may identify one of the first mapping data or the second mapping data as duplicate data (S1941). Operation S1941 may correspond to operation S1343 of FIG. 13, operation S1643 of FIG. 16, and operation S1743 of FIG. 17. Therefore, a redundant description is omitted.

Here, the electronic device 100 may acquire first feature data based on a first image included in the first mapping data (S1942). Here, the first feature data may include at least one feature (or object) acquired based on the first image.

Here, the electronic device 100 may acquire second feature data based on a second image included in the second mapping data (S1943). Here, the second feature data may include at least one feature (or object) acquired based on the second image.

Here, the electronic device 100 may identify whether the number of the first feature data is less than the number of the second feature data (S1944). The electronic device 100 may compare the number of features (or objects) included in the first feature data with the number of features (or objects) included in the second feature data.

If the number of the first feature data is less than the number of the second feature data (S1944—Y), the electronic device 100 may identify the first mapping data corresponding to the first feature data as duplicate data (S1945).

If the number of the first feature data is not less than the number of the second feature data (S1944—N), the electronic device 100 may identify the second mapping data corresponding to the second feature data as duplicate data (S1946).

Also, the electronic device 100 may delete the identified duplicate data (S1947). As a result, the electronic device 100 may delete only one of the first mapping data or the second mapping data.

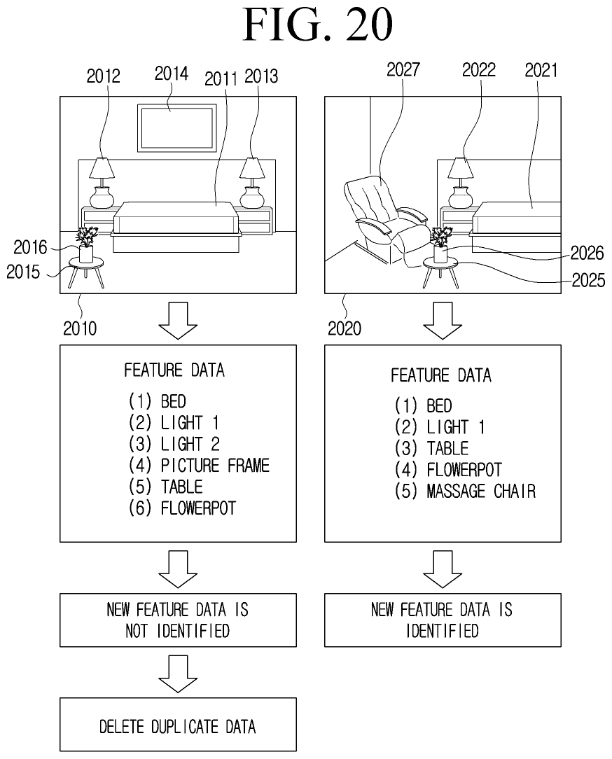

FIG. 20 is a diagram illustrating an operation of deleting duplicate data based on whether new feature data is identified.

Referring to FIG. 20, the electronic device 100 may acquire feature data included in a first image 2010 and feature data included in a second image 2020.

The first image 2010 may include a bed object 2011, a first light object 2012, a second light object 2013, a picture frame object 2014, a table object 2015, and a flowerpot object 2016.

The second image 2020 may include a bed object 2021, a first light object 2022, a table object 2025, a flowerpot object 2026, and a massage chair object 2027.

Here, the bed object 2011 and the bed object 2021 may be the same object. In addition, the first light object 2012 and the first light object 2022 may be the same object. In addition, the table object 2015 and the table object 2025 may be the same object. In addition, the flowerpot object 2016 and the flowerpot object 2026 may be the same object.

The electronic device 100 may acquire feature data based on the first image 2010. Here, the electronic device 100 may acquire a plurality of objects as feature data. The electronic device 100 may identify whether the feature data of the first image 2010 includes new feature data. Here, the electronic device 100 may store various feature data acquired in space in advance. The electronic device 100 may identify whether new feature data is identified by comparing feature data acquired from the first image 2010 with previously stored feature data. In FIG. 20, it is assumed that there is no new feature data in the first image 2010. Here, the electronic device 100 may identify mapping data corresponding to the first image 2010 as duplicate data. Then, the electronic device 100 may delete the duplicate data.

The electronic device 100 may acquire feature data based on the second image 2020. Here, the electronic device 100 may acquire a plurality of objects as feature data. The electronic device 100 may identify that new feature data (e.g., a massage chair) is included in the feature data acquired from the second image 2020. Therefore, the electronic device 100 may not identify mapping data corresponding to the second image 2020 including the new feature data as duplicate data.

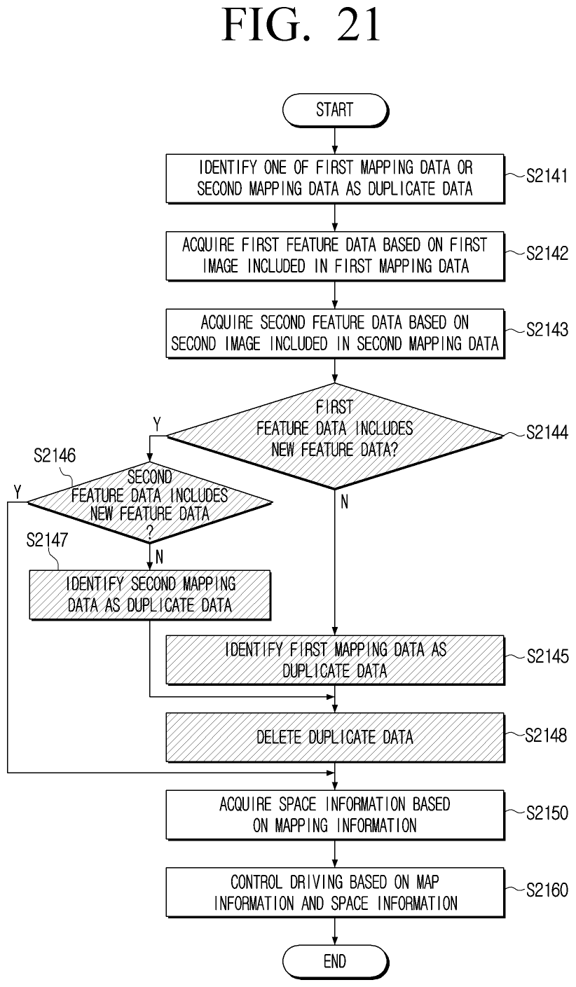

FIG. 21 is a flowchart illustrating an operation of deleting duplicate data based on whether new feature data is identified.

S2141, S2142, S2143, S2150, and S2160 of FIG. 21 may correspond to operations S1941, S1942, S1943, S1950, and S1960 of FIG. 19. Therefore, a redundant description is omitted.

After acquiring the first feature data and the second feature data, the electronic device 100 may identify whether the first feature data includes new feature data (S2144). The electronic device 100 may identify a first space in which the first mapping data and the second mapping data are acquired. The electronic device 100 may store the feature data acquired in the identified first space in advance. The electronic device 100 may determine whether the first feature data includes new feature data based on a plurality of feature data acquired in the first space.

If the first feature data does not include new feature data (S2144—N), the electronic device 100 may identify the first mapping data as duplicate data (S2145). If the first feature data includes new feature data (S2144—Y), the electronic device 100 may identify whether the second feature data includes new feature data (S2146).

If the second feature data does not include new feature data (S2146—N), the electronic device 100 may identify the second mapping data as duplicate data (S2147).

Then, the electronic device 100 may delete the identified duplicate data (S2148). Thereafter, the electronic device 100 may perform operations S2150 and S2160.

Meanwhile, if the second feature data includes new feature data (S2146—Y), the electronic device 100 may perform operations S2150 and S2160 directly, without deleting the duplicate data.

FIG. 22 is a view illustrating an operation of deleting duplicate data based on the number of feature data according to various embodiments.

Referring to FIG. 22, the electronic device 100 may acquire feature data included in a first image 2210 and feature data included in a second image 2220.

The first image 2210 may include a desk object 2211, a first chair object 2212, a second chair object 2213, a third chair object 2214, and a fourth chair object 2215.

The second image 2220 may include a couch object 2221.

The electronic device 100 may acquire feature data based on the first image 2210. Here, the electronic device 100 may acquire a plurality of objects as feature data. The electronic device 100 may identify the number of feature data (e.g., 5) of the first image 2210.

The electronic device 100 may acquire feature data based on the second image 2220. The electronic device 100 may identify the number of feature data (e.g., 1) of the second image 2220.

The electronic device 100 may identify the second image 2220 including feature data less than or equal to a threshold number (e.g., 2). Then, the electronic device 100 may identify mapping data corresponding to the second image 2220 as duplicate data. Then, the electronic device 100 may delete the duplicate data.

FIG. 18 illustrates an operation of deleting one of two mapping data (first mapping data or second mapping data) that are targets of duplicate data.

Unlike FIG. 18, FIG. 22 illustrates an operation of identifying duplicate data among the entire mapping data.

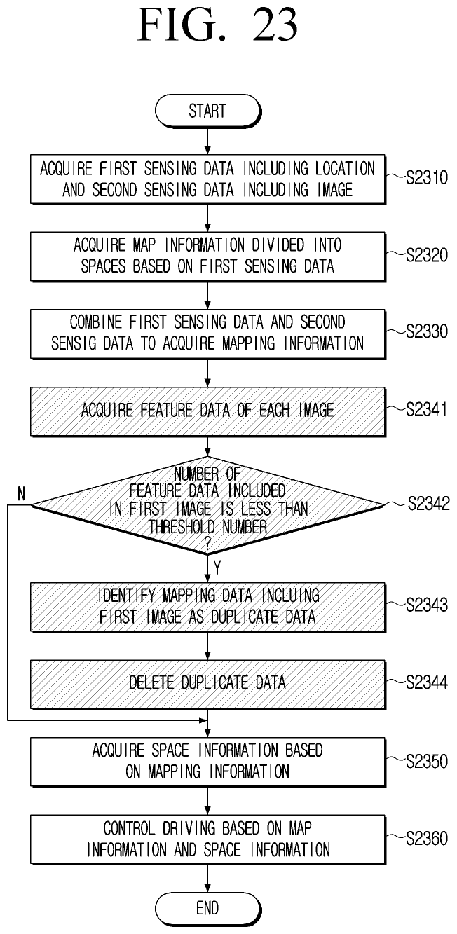

FIG. 23 is a flowchart illustrating an operation of deleting duplicate data based on the number of feature data according to various embodiments.

S2310, S2320, S2330, S2350, and S2360 of FIG. 23 may correspond to S710, S720, S730, S750, and S760 of FIG. 7. Therefore, a redundant description is omitted.

After acquiring mapping information, the electronic device 100 may acquire feature data of each image (S2341). The electronic device 100 may identify whether the number of feature data included in the first image is less than a threshold number (S2342).

If the number of feature data included in the first image is less than a threshold number (S2342—Y), the electronic device 100 may identify the mapping data including the first image as duplicate data (S2343). Then, the electronic device 100 may delete the duplicate data (S2344). Thereafter, the electronic device 100 may perform operations S2350 to S2360.

Meanwhile, if the number of feature data included in the first image is not less than the threshold number (S2342—N), the electronic device 100 may perform operations S2350 to S2360 directly, without deleting duplicate data.

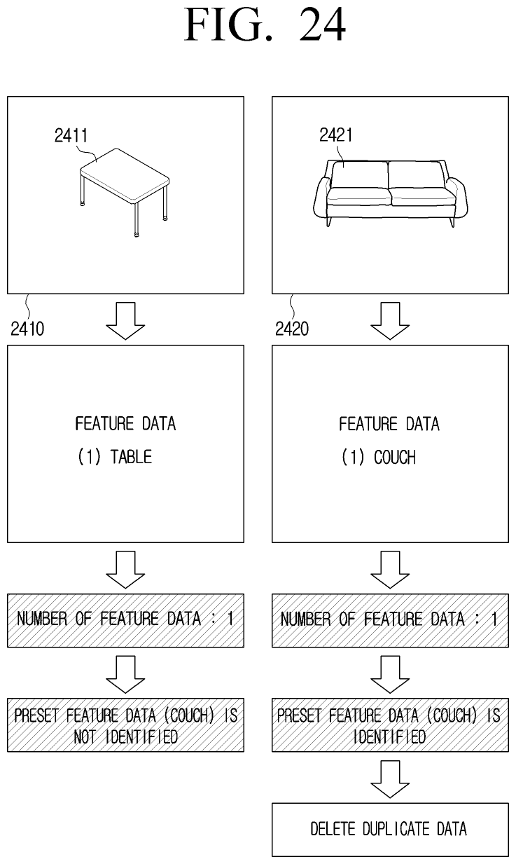

FIG. 24 is a view illustrating an operation of deleting duplicate data based on whether preset feature data is included.

Referring to FIG. 24, the electronic device 100 may acquire feature data included in a first image 2410 and feature data included in a second image 2420.

The first image 2410 may include a desk object 2411.

The second image 2420 may include a couch object 2421.

The electronic device 100 may acquire feature data based on the first image 2410. The electronic device 100 may identify the number of feature data (e.g., 1) of the first image 2410.

The electronic device 100 may acquire feature data based on the second image 2420. The electronic device 100 may identify the number of feature data (e.g., 1) of the second image 2420.

The electronic device 100 may identify the first image 2410 and the second image 2420 including feature data less than or equal to a threshold number (e.g., 2). Then, the electronic device 100 may identify whether preset feature data is included in the identified image. Here, the preset feature data may refer to data that is relatively unhelpful for image analysis. The preset feature data may refer to feature data that has a low contribution to a driving function or location identification operation of the electronic device 100. For example, the preset feature data is assumed to be a couch.

For example, the electronic device 100 may identify the second image 2420 including preset feature data (couch) among images 2410 and 2420 having feature data less than the threshold number. Then, the electronic device 100 may identify mapping data corresponding to the second image 2420 as duplicate data. Also, the electronic device 100 may delete the duplicate data.

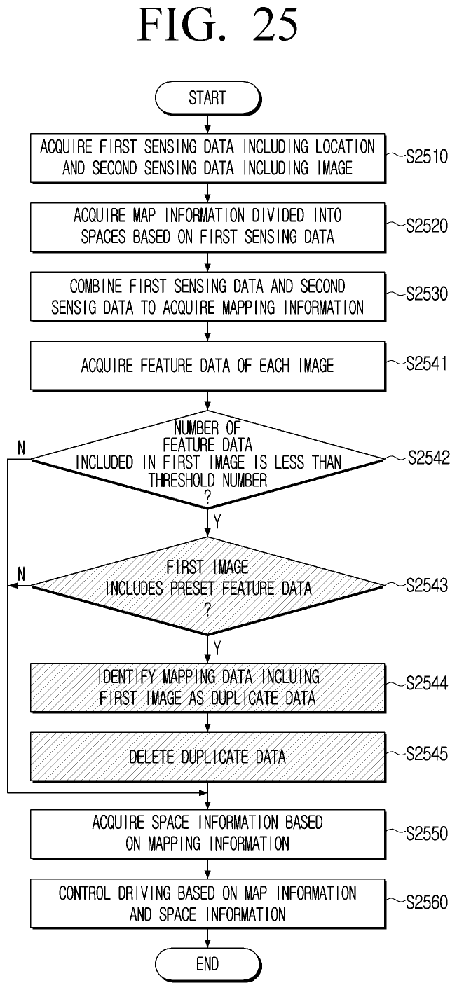

FIG. 25 is a flowchart illustrating an operation of deleting duplicate data based on whether preset feature data is included.

Operations S2510, S2520, S2530, S2541, S2542, S2550, and S2560 of FIG. 25 may correspond to operations S2310, S2320, S2330, S2341, S2342, S2350, and S2360 of FIG. 23. Therefore, a redundant description is omitted.

If the number of feature data included in the first image is less than the threshold number (S2542—Y), the electronic device 100 may identify whether the first image includes preset feature data (S2543).

If the first image includes preset feature data (S2543—Y), the electronic device 100 may identify mapping data including the first image as duplicate data (S2544). Then, the electronic device 100 may delete the duplicate data (S2545). Thereafter, the electronic device 100 may perform operations S2350 to S2360.

If the first image does not include preset feature data (S2543—N), the electronic device 100 may perform operations S2350 to S2360 directly without deleting the first image as duplicate data.

FIG. 26 is a view illustrating an operation of deleting duplicate data based on a preset location.

Referring to FIG. 26, the electronic device 100 may acquire a first image 2610 and a second image 2620. Here, a location at which the first image 2610 is acquired may be (x3, y4), and a location at which the second image 2620 is acquired may be (x3, y2).

Since a location and an image are combined with the mapping data, the electronic device 100 may know the location at which the image was captured. The electronic device 100 may identify whether the location corresponding to the image is a preset location. Here, the preset location may refer to a location that is relatively unhelpful for image analysis. The preset location may refer to a location that has a low contribution to the driving function or location identification operation of the electronic device 100. For example, the preset location may be a location (a first location) corresponding to a passage.

The electronic device 100 may identify the second image 2620 captured at the preset location. Also, the electronic device 100 may identify mapping data corresponding to the second image 2620 as duplicate data. Also, the electronic device 100 may delete the duplicate data.

FIG. 27 is a flowchart illustrating an operation of deleting duplicate data based on a preset location.

S2710, S2720, S2730, S2750, and S2760 of FIG. 27 may correspond to S710, S720, S730, S750, and S760 of FIG. 7. Therefore, a redundant description is omitted.

After acquiring the mapping information, the electronic device 100 may acquire a preset first location (S2741). Here, the first location may be a region or location corresponding to a passage. Here, the electronic device 100 may acquire a preset region (a region corresponding to a passage) or a preset location (a location corresponding to a passage) based on the map information.

The electronic device 100 may determine whether mapping data corresponding to the preset first location is identified (S2742). The electronic device 100 may determine whether the mapping data corresponds to the first location based on the location included in the mapping data.

If the mapping data corresponding to the preset first location is identified (S2742-Y), the electronic device 100 may identify the mapping data corresponding to the first location as duplicate data (S2743). Then, the electronic device 100 may delete the duplicate data (S2744). Thereafter, the electronic device 100 may perform operations S2750 to S2760.

Meanwhile, if the mapping data corresponding to the preset first location is not identified (S2742—N), the electronic device 100 may perform operations S2750 to S2760 directly, without deleting the duplicate data.

FIG. 28 is a view illustrating an operation of deleting duplicate data based on feature data corresponding to a plurality of spaces.

Referring to FIG. 28, the electronic device 100 may acquire a first image 2810 and a second image 2820.

Here, the first image 2810 may include a bed object 2811. In addition, the second image 2820 may include a bed object 2821 and a wall object 2822. Here, the bed object 2811 and the bed object 2821 may be the same object.

Here, a location at which the first image 2810 is acquired may be (x3, y4), and a location at which the second image 2820 is acquired may be (x3, y2).

Here, the electronic device 100 may identify that a space in which the first image 2810 was captured is a second space based on the location (x3, y4). In addition, the electronic device 100 may identify that a space in which the second image 2820 was captured is a first space based on the location (x3, y2).

Here, the electronic device 100 may identify feature data included in the image. Also, the electronic device 100 may determine which space the feature data acquired from the image corresponds to.

The first image 2810 may be an image captured in the second space, and the bed object 2811 acquired in the first image 2810 may be an object located in the second space.

The second image 2820 may be an image captured in the first space, and the bed object 2821 acquired in the second image 2820 may be an object located in the second space.

Since the second image 2820 is an image captured in the first space but includes an object located in the second space, the electronic device 100 may determine the second image 2820 as duplicate data or unnecessary data. Then, the electronic device 100 may delete the duplicate data or unnecessary data.

FIG. 29 is a flowchart illustrating an operation of deleting duplicate data based on feature data corresponding to a plurality of spaces.

S2910, S2920, S2930, S2950, and S2960 of FIG. 29 may correspond to S710, S720, S730, S750, and S760 of FIG. 7. Therefore, a redundant description is omitted.

After acquiring mapping information, the electronic device 100 may acquire feature data corresponding to a plurality of spaces (S2941). Then, the electronic device 100 may identify a first space corresponding to a first image based on first sensing data (S2942).

The electronic device 100 may identify whether the first image corresponding to the first space includes feature data corresponding to the second space (S2943). If the first image corresponding to the first space includes feature data corresponding to the second space (S2943—Y), the electronic device 100 may identify the mapping data including the first image as duplicate data (S2944). Then, the electronic device 100 may delete duplicate data (S2945). Thereafter, the electronic device 100 may perform operations S2950 to S2960.

Meanwhile, if the first image corresponding to the first space does not include feature data corresponding to the second space (S2943—N), the electronic device 100 may perform operations S2950 to S2960 directly, without deleting the duplicate data.

FIG. 30 is a view illustrating space information according to various embodiments.

Table 3010 of FIG. 30 illustrates space information acquired without deleting duplicate data. The electronic device 100 may identify a wall object 7 times, a desk object 5 times, a chair object 5 times, a door object 3 times, and a couch object 3 times in the first space.

Also, the electronic device 100 may acquire a weight corresponding to feature data according to the accumulated number or rank. A feature identified more frequently in a specific space has a higher weight. The acquired weight may be used in a driving path setting operation or a location re-recognition operation of the electronic device 100.

Here, the electronic device 100 may perform an operation of deleting duplicate data. For example, it is assumed that an image including a wall object, a bed object, and a couch object is deleted as duplicate data.

The electronic device 100 may acquire space information based on mapping information from which the image including the wall object, the bed object, and the couch object was removed.

Table 3020 of FIG. 30 illustrates space information acquired in a state in which duplicate data is deleted. The electronic device 100 may identify a wall object 11 times, a dining table object 5 times, a bed object 4 times, an air-conditioner object 3 times, and a door object 3 times in the second space.

In addition, the electronic device 100 may acquire a weight corresponding to the feature data according to the accumulated number or rank. Table 3020 may represent space information acquired in a state in which the analysis targets are reduced compared to table 3010. Therefore, the electronic device 100 may shorten the processing time required to acquire space information.

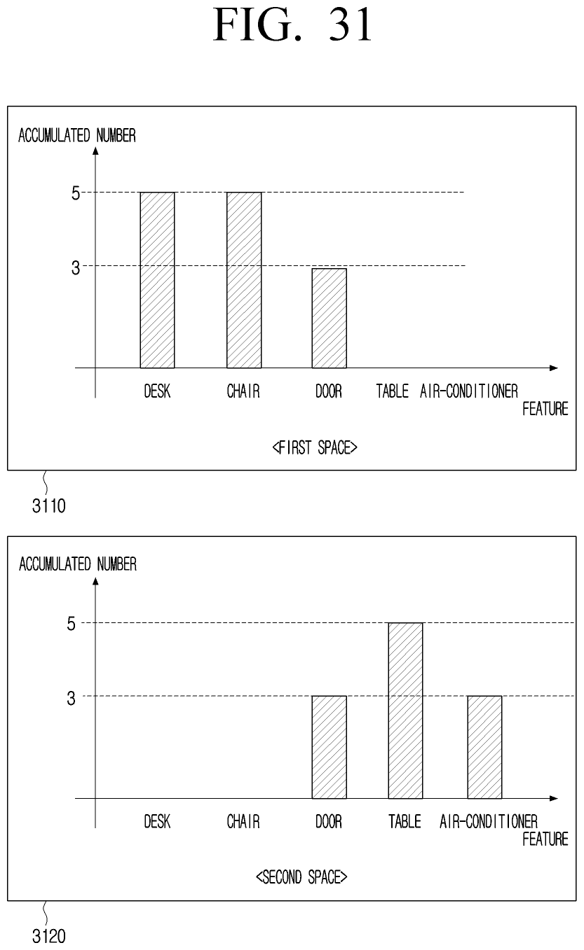

FIG. 31 is a diagram illustrating space information according to various embodiments.

Table 3110 of FIG. 31 represents the cumulative number of feature data corresponding to the first space. The electronic device 100 may calculate the cumulative number of feature data identified in the first space and store the calculated information as space information.

Table 3120 of FIG. 31 represents the cumulative number of feature data corresponding to the second space. The electronic device 100 may calculate the cumulative number of feature data identified in the second space and store the calculated information as space information.

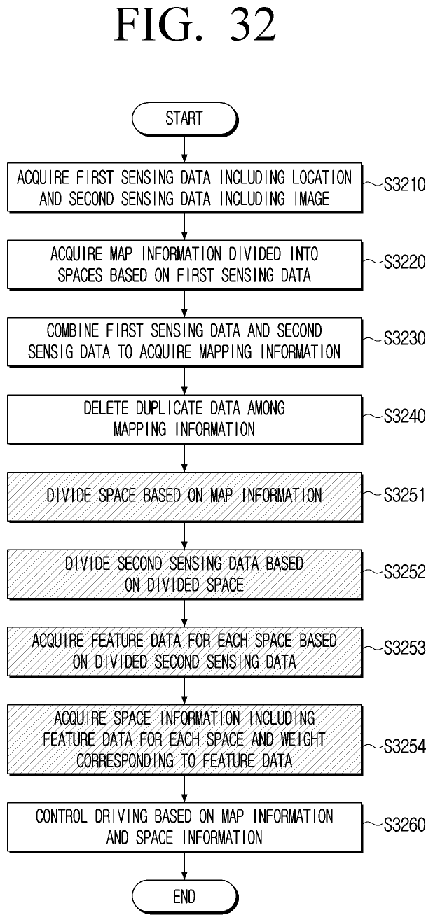

FIG. 32 is a flowchart illustrating an operation of acquiring feature data of each of a plurality of spaces.

S3210, S3220, S3230, S3240, and S3260 of FIG. 32 may correspond to S710, S720, S730, S740, and S760 of FIG. 7. Therefore, a redundant description is omitted.

After deleting duplicate data, the electronic device 100 may divide a space based on map information (S3251). The electronic device 100 may divide the entire map data into at least one space.

Here, the electronic device 100 may divide the second sensing data based on the divided space (S3252). The electronic device 100 may divide the entire second sensing data into a first group corresponding to the first space and a second group corresponding to the second space. The second sensing data may include the first group and the second group.

Here, the electronic device 100 may acquire feature data for each space based on the divided second sensing data (S3253). The electronic device 100 may acquire feature data for the first space based on the first group. In addition, the electronic device 100 may acquire feature data for the second space based on the second group.

Here, the electronic device 100 may acquire feature data for each space and space information including weights corresponding to the feature data (S3254). The space information including weights is described in FIG. 30.

Thereafter, the electronic device 100 may perform operation S3260. The electronic device 100 may acquire feature data from a captured image acquired at the time of re-recognizing a location. The electronic device 100 may determine whether feature data included in the space information in the acquired captured image is identified. Then, the electronic device 100 may recognize the location of the electronic device 100 based on a determination result.

FIG. 33 is a view illustrating an operation of an electronic device 100 re-recognizing a location.

Referring to FIG. 33, the electronic device 100 may acquire entire map data 3300. Here, the entire map data 3300 may be included in map information. The entire map data 3300 may be divided into a first space 3310 and a second space 3320 based on an outline. The electronic device 100 may drive from a specific location in the first space to a specific location in the second space.

It is assumed that the electronic device 100 has completed driving to a specific location. Here, the electronic device 100 may return to a charging location after completing driving. The electronic device 100 may re-recognize the current location for returning. The electronic device 100 may use map information and space information when performing a location re-recognition operation.

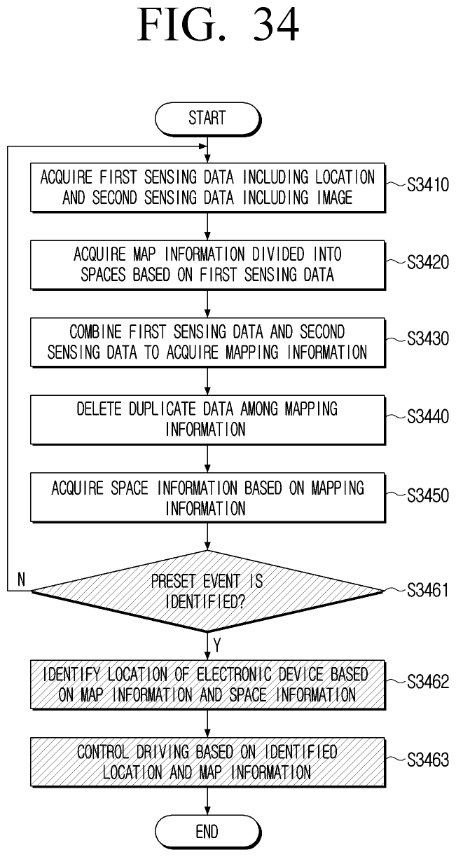

FIG. 34 is a flowchart illustrating an operation of an electronic device 100 re-recognizing a location based on a preset event.

S3410, S3420, S3430, S3440, and S3450 of FIG. 34 may correspond to S710, S720, S730, S740, and S750 of FIG. 7. Therefore, a redundant description is omitted.

After acquiring space information, the electronic device 100 may determine whether a preset event is identified (S3461). Here, the preset event may refer to an event requiring location re-recognition. The event described in FIG. 10 may be different from the event described in FIG. 34.

The preset event may include at least one of an event in which the electronic device 100 moves by a threshold distance or more, an event in which driving is terminated, or an event in which a user command is received during driving.

Here, the event in which the electronic device 100 moves by the threshold distance or more may indicate a situation in which a user directly moves the electronic device 100 to a different location. The user may directly move the electronic device 100 in a situation in which the electronic device 100 is fixed to a specific location and cannot move or in a situation in which the electronic device is present in a space in which driving is considered unnecessary. The electronic device 100 may identify such a situation and re-recognize the location of the electronic device 100.

If a preset event is identified (S3461—Y), the electronic device 100 may identify (or recognize) the location of the electronic device 100 based on map information and space information (S3462). Then, the electronic device 100 may control driving based on the identified location and map information (S3463).

Meanwhile, if the preset event is not identified (S3461—N), the electronic device 100 may repeat operations S3410 to S3461.

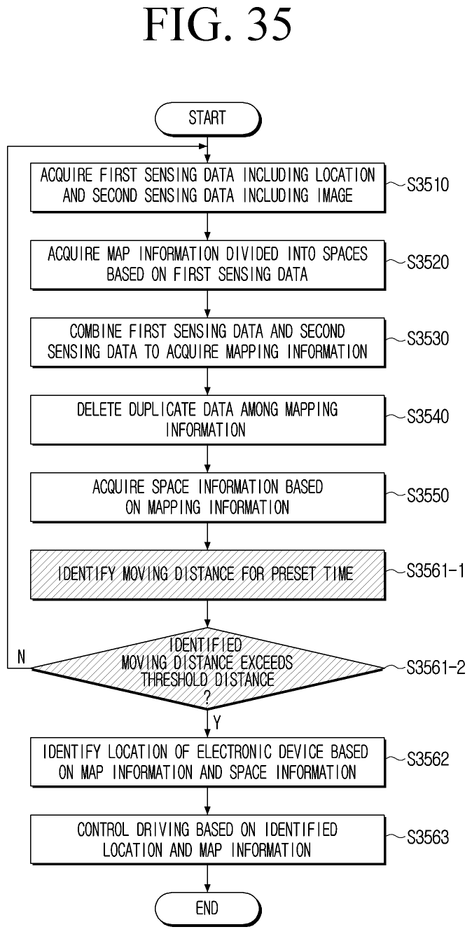

FIG. 35 is a flowchart illustrating an operation of the electronic device 100 re-recognizing a location based on a moving distance of the electronic device 100.

Operations S3510, S3520, S3530, S3540, S3550, S3562, and S3563 of FIG. 35 may correspond to operations S3410, S3420, S3430, S3440, S3450, S3462, and S3463 of FIG. 34. Therefore, a redundant description is omitted.

After acquiring space information, the electronic device 100 may identify a moving distance by which the electronic device 100 has moved for a preset time (S3561-1). For example, the electronic device 100 may acquire a distance value by which the electronic device 100 has moved for 5 seconds.

Here, the electronic device 100 may identify whether the identified moving distance exceeds a threshold distance (S3561-2). If the identified moving distance exceeds the threshold distance (S3561-2—Y), the electronic device 100 may perform operations S3562 to S3563.

Meanwhile, if the identified moving distance does not exceed the threshold distance (S3561-2—N), the electronic device 100 may repeat operations S3510 to S3561-2.

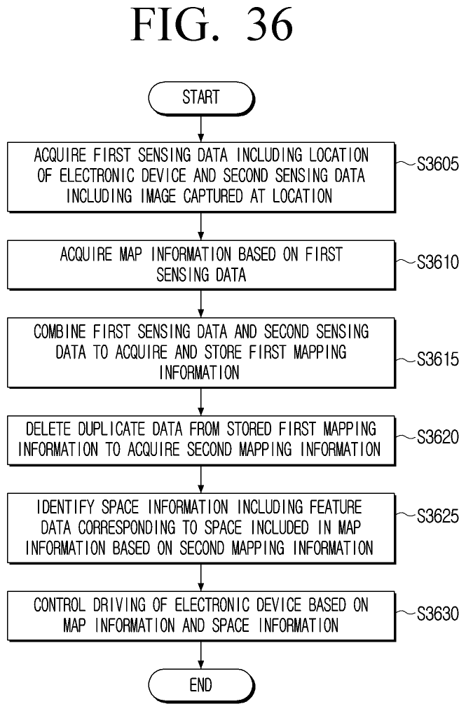

FIG. 36 is a flowchart illustrating a control method of the electronic device 100 according to various embodiments.

Referring to FIG. 36, a control method of an electronic device may include an operation of acquiring first sensing data including a location of an electronic device and second sensing data including an image captured at the location (S3605), an operation of acquiring map information based on the first sensing data (S3610), an operation of acquiring and storing first mapping information by combining the first sensing data and the second sensing data (S3615), an operation of deleting duplicate data corresponding to a repeated image in the stored first mapping information (or data corresponding to a preset condition) to acquire second mapping information (S3620), an operation of identifying space information including feature data corresponding to a space included in the map information based on the second mapping information (S3625), and an operation of controlling driving of the electronic device based on the map information and the space information (S3630).

Meanwhile, in the operation of identifying space information (S3625), the space is identified based on map information and feature data corresponding to the space is acquired based on an image captured in the space in the second mapping information, and in the operation of controlling the driving of the electronic device, space information including the feature data corresponding to the space may be stored.

Meanwhile, in the operation of controlling the driving of the electronic device (S3630), when a preset event is identified, the location of the electronic device may be identified based on the map information and the space information, and the preset event may include at least one of an event in which the electronic device moves by a threshold distance or more, an event in which driving is terminated, or an event in which a user command is received during driving.

Meanwhile, in the operation of acquiring the first sensing data and the second sensing data (S3605), the first sensing data may be acquired through the lidar sensor of the electronic device and the second sensing data may be acquired through the image sensor of the electronic device.

Meanwhile, in the operation of acquiring the first sensing data and the second sensing data (S3605), when a user input for driving the electronic device is received, the first sensing data and the second sensing data may be acquired while driving corresponding to the user input is performed, and when the driving is terminated, the duplicate data (or data corresponding to a preset condition) may be deleted from the first mapping information to acquire the second mapping information.

Meanwhile, in the operation of storing the first mapping information (S3615), the location and image sensed at the same time may be combined to acquire the first mapping information.

Meanwhile, the first mapping information may include a plurality of mapping data, and in the operation of acquiring the second mapping information (S3620), the duplicate data (or data corresponding to a preset condition) among the plurality of mapping data may be identified based on at least one of the location, the sensing time, or the rotation angle.

Meanwhile, the first mapping information may include the first mapping data and the second mapping data, and in the operation of acquiring the second mapping information (S3620), one of the first mapping data or the second mapping data may be identified as duplicate data (or data corresponding to a preset condition) if a difference value between the location of the first mapping data and the location of the second mapping data is less than a threshold distance.

Meanwhile, in the operation of acquiring the second mapping information (S3620), the mapping data corresponding to the preset location among the plurality of mapping data may be identified as duplicate data (or data corresponding to a preset condition).

Meanwhile, the first mapping information may include the plurality of mapping data, and in the operation of acquiring the second mapping information (S3620), the duplicate data (or data corresponding to a preset condition) among the plurality of mapping data in at least one of the number of feature data or the preset feature data may be identified.

Meanwhile, the control method of an electronic device, such as that of FIG. 36, may be executed on the electronic device having the configuration of FIG. 1 or FIG. 2, and may also be executed on an electronic device having other components.

Meanwhile, the methods according to the various embodiments of the present disclosure described above may be implemented in the form of an application that may be installed on an existing electronic device.

In addition, the methods according to the various embodiments of the present disclosure described above may be implemented only with a software upgrade or a hardware upgrade for an existing electronic device.

In addition, the various embodiments of the present disclosure described above may also be performed through an embedded server provided in an electronic device or an external server of at least one of the electronic device or the display device.

Meanwhile, according to an embodiment of the disclosure, the aforementioned various embodiments may be implemented as software including instructions stored in machine-readable storage media, which may be read by machines (e.g.: computers). The machines refer to devices that call instructions stored in a storage medium, and may operate according to the called instructions, and the devices may include an electronic device according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it may be traded between a seller and a buyer. A computer program product may be distributed in the form of a storage medium that is readable by machines (e.g.: a compact disc read only memory (CD-ROM)), or may be distributed on-line through an application store (e.g.: Play Store™). In the case of on-line distribution, at least a portion of a computer program product may be stored in a storage medium, such as the server of the manufacturer, the server of the application store, and the memory of the relay server at least temporarily, or may be generated temporarily.

Further, each of the components according to the aforementioned various embodiments (e.g.: a module or a program) may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

So far, preferred embodiments of the disclosure have been shown and described, but the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

1. An electronic device comprising:
a sensor unit;
a memory; and
at least one processor configured to:
acquire first sensing data including a location of the electronic device and second sensing data including an image captured at the location through the sensor unit,
acquire map information based on the first sensing data,
combine the first sensing data and the second sensing data to acquire first mapping information and store the acquired first mapping information in the memory,
delete data corresponding to a preset condition from the stored first mapping information to acquire second mapping information,
identify space information of a space in which the electronic device is to be driven which includes feature data corresponding to the space included in the map information based on the second mapping information, and
control driving of the electronic device in the space based on the map information and the space information.

2. The electronic device of claim 1, wherein
the at least one processor is configured to:
identify the space based on the map information,
acquire the feature data corresponding to the space based on an image captured in the space that is among the second mapping information, and
store the space information including the feature data corresponding to the space in the memory.

3. The electronic device of claim 1, wherein
the at least one processor is configured to identify, based on a preset event being identified, the location of the electronic device based on the map information and the space information, and
the preset event includes at least one of an event in which the electronic device is moved by more than a threshold distance, an event in which driving of the electronic device is terminated, or an event in which a user command is received during driving of the electronic device.

4. The electronic device of claim 1, wherein the sensor unit includes a lidar sensor and an image sensor, and the at least one processor is configured to acquire the first sensing data through the lidar sensor and acquire the second sensing data through the image sensor.

5. The electronic device of claim 1, wherein the at least one processor is configured to acquire, based on a user input received for driving the electronic device, the first sensing data and the second sensing data while the driving corresponding to the user input is performed, and delete, based on termination of the driving, data corresponding to the preset condition from the first mapping information to acquire the second mapping information.

6. The electronic device of claim 1, wherein the at least one processor is configured to combine location and image sensed at a same time to acquire the first mapping information.

7. The electronic device of claim 1, wherein the first mapping information includes a plurality of mapping data, and the at least one processor is configured to identify data corresponding to the preset condition among the plurality of mapping data based on at least one of a location, a sensing time, or a rotation angle.

8. The electronic device of claim 7, wherein
the first mapping information includes first mapping data and second mapping data, and the at least one processor is configured to identify one of the first mapping data or the second mapping data as data corresponding to the preset condition based on a difference between a location of the first mapping data and a location of the second mapping data being less than a threshold distance.

9. The electronic device of claim 7, wherein the at least one processor is configured to identify mapping data corresponding to a preset location among the plurality of mapping data as data corresponding to the preset condition.

10. The electronic device of claim 1, wherein the first mapping information includes a plurality of mapping data, and the at least one processor is configured to identify data corresponding to the preset condition among the plurality of mapping data, based on a number of feature data or at least one of preset feature data.

11. A control method of an electronic device, the control method comprising:
acquiring first sensing data including a location of the electronic device and second sensing data including an image captured at the location;
acquiring map information based on the first sensing data;
combining the first sensing data and the second sensing data to acquire and store first mapping information;
deleting data corresponding to a preset condition corresponding to a repeated image in the stored first mapping information to acquire second mapping information;
identifying space information of a space in which the electronic device is to be driven which includes feature data corresponding to the space included in the map information based on the second mapping information; and
controlling driving of the electronic device in the space based on the map information and the space information.

12. The control method of claim 11, wherein
the identifying of the space information includes:
identifying the space based on the map information; and
acquiring the feature data corresponding to the space based on an image captured in the space that is among the second mapping information, and
the controlling of the driving of the electronic device includes storing the space information including the feature data corresponding to the space.

13. The control method of claim 11, wherein
the controlling of the driving of the electronic device includes:
identifying, based on a preset event being identified, the location of the electronic device based on the map information and the space information, and
the preset event includes at least one of an event in which the electronic device is moved by more than a threshold distance, an event in which driving of the electronic device is terminated, or an event in which a user command is received during driving of the electronic device.

14. The control method of claim 11, wherein
the acquiring of the first sensing data and the second sensing data includes:
acquiring the first sensing data through a lidar sensor of the electronic device, and
acquiring the second sensing data through an image sensor of the electronic device.

15. The control method of claim 11, wherein
the acquiring of the first sensing data and the second sensing data includes acquiring, based on a user input received for driving the electronic device, the first sensing data and the second sensing data while the driving corresponding to the user input is performed, and deleting, based on termination of the driving, data corresponding to the preset condition from the first mapping information to acquire the second mapping information.
